(19) United States
(12) Patent Application Publication
(10) Pub. No.: US 2026/0150082 A1
(43) Pub. Date: May 28, 2026

(54) POSITIONING SYSTEM AND METHOD

(71) Applicants: ZHONGTIAN RADIO FREQUENCY CABLE CO., LTD., Nantong, Jiangsu (CN); JIANGSU ZHONGTIAN TECHNOLOGY CO., LTD., Nantong, Jiangsu (CN)

(72) Inventors: Longlong LIN, Nantong (CN); Zongming XU, Nantong (CN); Jiafeng ZHANG, Nantong (CN); Binbin XU, Nantong (CN); Yunkun ZHAO, Nantong (CN); Ruijing ZHAO, Nantong (CN); Bin WANG, Nantong (CN); Bohua XU, Nantong (CN); Yanrui LAN, Nantong (CN); Yichun SHEN, Nantong (CN)

(73) Assignees: ZHONGTIAN RADIO FREQUENCY CABLE CO., LTD., Nantong, Jiangsu (CN); JIANGSU ZHONGTIAN TECHNOLOGY CO., LTD., Nantong, Jiangsu (CN)

(21) Appl. No.: 19/123,481

(22) PCT Filed: Oct. 20, 2023
(86) PCT No.: PCT/CN2023/125764

§ 371 Date: Apr. 23, 2025

(30) Foreign Application Priority Data
May 17, 2023 (CN) 202310558567.X

(51) Int. Cl. H04W 64/00

(52) U.S. Cl. CPC H04W 64/003

(57) ABSTRACT

A positioning system and method. The positioning system includes a positioning base station including a positioning module, n data transceiving modules, each of which include at least one positioning signal transceiving area and a parsing module; the positioning module is configured to perform information interaction with a terminal device through the positioning signal transceiving area, so as to generate a sending feature and a receiving feature; and the parsing module is configured to receive the sending feature and the receiving feature as well as a corresponding positioning module identifier and a corresponding terminal device identifier; determine at least one transmission feature quantity according to the sending feature and the receiving feature as well as the corresponding positioning module identifier and the corresponding terminal device identifier; and determine a first spatial coordinate of the terminal device according to each transmission feature quantity and each positioning module identifier.

### CROSS-REFERENCE TO RELATED APPLICATION

This application is a National Stage of International Application No. PCT/CN 2023/125764, filed on Oct. 20, 2023, which claims priority to Chinese Patent Application No. 202310558567.X, filed with the China National Intellectual Property Administration on May 17, 2023 and entitled “POSITIONING SYSTEM AND METHOD”. The two applications are hereby incorporated by reference in their entireties.

### TECHNICAL FIELD

The present application relates to the field of positioning technologies and, in particular, to a positioning system and method.

### BACKGROUND

With the increasing demand for mobile navigation and autonomous driving, the user's requirements for positioning accuracy are gradually increased.

At present, satellite positioning or base station positioning is usually adopted in the related art. However, in indoor areas, tunnels and places where satellite signals are blocked, it is difficult for the satellite signals to reach mobile phones, and positioning is usually carried out by using signals emitted by base stations.

However, the inventor finds that the related art has at least the following technical problems: the current positioning method using the signals emitted by the base stations tends to result in inaccurate positioning when the number of the base stations is relatively small; and there is a multi-path effect in the positioning of conventional leaky cables resulting in difficulty in to solving.

### SUMMARY

The present application provides a positioning system and method, which are used for solving the problem of inaccurate positioning and the problem of difficulty in solution caused by the multi-path effect.

According to a first aspect, the present application provides a positioning system, including: a positioning base station, n data transceiving module and a parsing module, where the positioning base station includes a positioning module, and each data transceiving module includes at least one positioning signal transceiving area, where n is a positive integer; the positioning module is connected to one end of the data transceiving module; the positioning module is configured to perform information interaction with a terminal device through the positioning signal transceiving area of the data transceiving module, so as to generate a sending feature and a receiving feature of each piece of information, where the sending feature includes a sending time or a sending phase, and the receiving feature includes a receiving time or a receiving phase; and the parsing module is configured to receive the sending feature and the receiving feature of each piece of information sent by the positioning module and/or the terminal device as well as a corresponding positioning module identifier and a corresponding terminal device identifier; determine at least one transmission feature quantity according to the sending feature and the receiving feature of each piece of information as well as the corresponding positioning module identifier and the corresponding terminal device identifier, where the transmission feature quantity includes a total transmission time or a total transmission phase difference, and corresponds to the positioning module identifier and the terminal device identifier; and determine a first spatial coordinate of the terminal device according to each transmission feature quantity and each positioning module identifier.

In this embodiment, by providing the positioning base station, the data transceiving module and the parsing module in the positioning system, the positioning module can perform information interaction with the terminal device through the positioning signal transceiving area in the data transceiving module to obtain the transmission feature quantity of each piece of information, and each transmission feature quantity is sent to the parsing module, and the parsing module determines the spatial coordinate of the terminal device according to each transmission feature quantity, thereby improving the positioning accuracy, positioning the spatial coordinate of the terminal device without satellite signals, and overcoming the problem of difficulty in position solution caused by the multi-path effect in conventional leaky cables.

In a possible implementation, the parsing module is configured to obtain a number of the transmission feature quantity, and determine the first spatial coordinate of the terminal device according to the number of the transmission feature quantity, each positioning module identifier and each transmission feature quantity.

Furthermore, by combining the number of the transmission feature quantity, each positioning module identifier and each transmission feature quantity, the spatial coordinate of the terminal device is obtained, so that the spatial coordinate of the terminal device is positioned without the satellite signals, thereby overcoming the problem of difficulty in position solution caused by the multi-path effect in conventional leaky cables.

In a possible implementation, the parsing module is configured to: if the number of the transmission feature quantity is greater than or equal to 3, determine a target position of each target positioning module according to the positioning module identifier, where the target positioning module is a positioning module that performs signal transmission and reception; determine an identifier of each corresponding target positioning signal transceiving area according to each transmission feature quantity and the corresponding positioning module identifier, where the target positioning signal transceiving area includes a positioning signal transceiving area through which each piece of information passes; search for each piece of target structural information corresponding to the identifier of each target positioning signal transceiving area; and determine the first spatial coordinate of the terminal device according to each piece of target structural information, the target position of each target positioning module and each transmission feature quantity.

Furthermore, in a case where the number of the transmission feature quantity is greater than or equal to 3, the target position of each target positioning module is determined according to the positioning module identifier, the identifier of each corresponding target positioning signal transceiving area is determined according to each transmission feature quantity and the corresponding positioning module identifier, each corresponding target structural information is obtained by searching for a corresponding relationship through the identifier of each corresponding target positioning signal transceiving area, and the spatial coordinate of the terminal device is obtained according to each piece of target structural information, the target position of each target positioning module and each transmission feature quantity, thereby achieving the effect of determining the spatial coordinate of the terminal device by combining the structural information of the positioning signal transceiving area and each transmission feature quantity, without using the satellite signals.

In a possible implementation, the target structural information includes a target angle of the target positioning signal transceiving area and a target distance from the positioning base station to the target positioning signal transceiving area, where the target positioning module is a positioning module that performs information interaction; and the parsing module is configured to: search for a preset corresponding relationship between the transmission feature quantity, the positioning module identifier and an error according to each transmission feature quantity and the positioning module identifier, so as to obtain each target error; and input each target position, each target angle, each target distance, each target error and each transmission feature quantity into a preset formula, so as to obtain the first spatial coordinate of the terminal device.

Furthermore, by searching for the corresponding relationship between the transmission feature quantity, the positioning module identifier and the error, each target error corresponding to each transmission feature quantity is obtained, and each target position, each target angle, each target distance, each target error and each transmission feature quantity are input into the preset formula, so as to obtain the first spatial coordinate of the terminal device, thereby obtaining a three-dimensional coordinate of the terminal device through the transmission feature quantity, and enabling the positioning of the terminal device in complex environments.

In a possible implementation, the parsing module is configured to: if the number of the transmission feature quantity is 1 or 2, obtain a preset reference coordinate; determine a target position of each target positioning module according to the positioning module identifier, where the target positioning module is a positioning module that performs signal transmission and reception; determine an identifier of each corresponding target positioning signal transceiving area according to each transmission feature quantity and the corresponding positioning module identifier, where the target positioning signal transceiving area is a positioning signal transceiving area through which each piece of information passes; search for each piece of target structural information corresponding to the identifier of each target positioning signal transceiving area; and determine the first spatial coordinate of the terminal device according to the preset reference coordinate, each piece of target structural information, the target position of each target positioning module and each transmission feature quantity.

Furthermore, in a case where the number of receiving times of a feedback signal is limited so that the total transmission time is 1 or 2, the preset reference coordinate is read, the target position of the target positioning module is determined through the positioning module identifier, and each corresponding target positioning signal transceiving area is determined by combining each transmission feature quantity and the corresponding positioning module identifier, each piece of target structural information corresponding to the identifier of each corresponding target positioning signal transceiving area is searched for, and the spatial coordinate of the terminal device is determined through the preset reference coordinate, each piece of target structural information, each target position and each transmission feature quantity, so that in the case where the receiving number of times of the feedback signal is limited, the positioning of the terminal device can achieve the effects of reducing the calculation amount, reducing positioning time and reducing positioning costs in scenarios with relatively fixed coordinates, such as a tunnel.

In a possible implementation, the positioning module is configured to input a positioning signal to the data transceiving module, and record a sending time of the positioning signal; the data transceiving module is configured to send the positioning signal from the positioning signal transceiving area to an air; the data transceiving module is configured to receive a feedback signal, where the feedback signal is sent by the terminal device according to the positioning signal, and the feedback signal includes the terminal device identifier; the positioning module is configured to receive each feedback signal sent by the data transceiving module and record each receiving time corresponding to each feedback signal, and send each sending time, each receiving time, the corresponding positioning module identifier and the corresponding terminal device identifier to the parsing module; and the parsing module is configured to determine each corresponding total transmission time according each sending time, each receiving time, the corresponding positioning module identifier and the corresponding terminal device identifier; or the data transceiving module is configured to receive a positioning request transmitted by the terminal device through the positioning signal transceiving area, where the positioning request includes a sending time of the positioning request and a corresponding terminal device identifier; the positioning module is configured to receive each positioning request sent by the data transceiving module and record a receiving time of each positioning request, and send the sending time of each positioning request, the receiving time of each positioning request, the corresponding positioning module identifier and the corresponding terminal device identifier to the parsing module; and the parsing module is configured to determine each corresponding total transmission time according to the sending time of each positioning request, the receiving time of each positioning request, the corresponding positioning module identifier and the corresponding terminal device identifier; or the data transceiving module is configured to receive a positioning request transmitted by the terminal device through the positioning signal transceiving area, where the positioning request includes a sending time of the positioning request and a corresponding terminal device identifier; the positioning module is configured to receive each positioning request sent by the data transceiving module and record a receiving time of each positioning request, and input a positioning signal to the data transceiving module and record a sending time of each positioning signal; the data transceiving module is configured to send the positioning signal from the positioning signal transceiving area to an air; the data transceiving module is configured to receive a feedback signal and send the feedback signal to the positioning module, where the feedback signal is sent by the terminal device according to the positioning signal and includes a sending time of the feedback signal and a corresponding terminal device identifier; the positioning base station is configured to receive each feedback signal sent by the data transceiving module and record a receiving time of each feedback signal, and send the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier to the parsing module; and the parsing module is configured to determine each total transmission time according to the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier.

Furthermore, the positioning base station receives and sends a signal through the positioning signal transceiving area of the data transceiving module, and records the receiving time and the sending time of the signal, so as to calculate the transmission feature quantity, so that the spatial coordinate of the terminal device is determined according to the transmission feature quantity, thereby achieving the effect of improving the positioning accuracy and positioning the spatial coordinate of the terminal device without the satellite signals.

In a possible implementation, the data transceiving module includes a first data transceiving module and a second data transceiving module; and the system further includes: at least one connection module; where one end of the first data transceiving module is connected to the positioning module, and the other end of the first data transceiving module is connected to one end of the connection module; the second data transceiving module is connected to the connection module; and the connection module is configured to receive a positioning signal input by the positioning base station through the first data transceiving module and input the positioning signal into the second data transceiving module, so that the positioning signal is sent to an air through the second data transceiving module; and receive a feedback signal input by the terminal device through the second data transceiving module and send the feedback signal to the positioning base station through the first data transceiving module.

Furthermore, by providing the connection module and connecting it to the first data transceiving module and the second data transceiving module respectively, the signal input by the first data transceiving module is output to the second data transceiving module, so that the positioning signal is sent to the air through the second data transceiving module, and the feedback signal input by the terminal device through the second data transceiving module is received, and the feedback signal is input into the first data transceiving module, so that at least two data transceiving modules are connected in series, and information intercommunication is achieved, thereby achieving the effect of prolonging signal coverage range and positioning range of the positioning system.

In a possible implementation, the data transceiving module includes a first data transceiving module and a second data transceiving module; the system further includes: at least one connection module; and the connection module includes an auxiliary positioning module; where one end of the first data transceiving module is connected to the positioning module, and the other end of the first data transceiving module is connected to the auxiliary positioning module; the second data transceiving module is connected to the auxiliary positioning module; the connection module is configured to perform information interaction with the terminal device through a positioning signal transceiving area of the first data transceiving module and/or the second data transceiving module, so as to generate an auxiliary sending feature and an auxiliary receiving feature of each piece of information, where the auxiliary sending feature includes an auxiliary sending time or an auxiliary sending phase, and the auxiliary receiving feature includes an auxiliary receiving time or an auxiliary receiving phase; and the parsing module is configured to receive the auxiliary sending feature and the auxiliary receiving feature of each piece of information sent by the auxiliary positioning module and/or the terminal device as well as a corresponding auxiliary positioning module identifier and a corresponding terminal device identifier; determine at least one auxiliary transmission feature quantity according to each auxiliary sending feature and each auxiliary receiving feature as well as the corresponding auxiliary positioning module identifier and the corresponding terminal device identifier, where the auxiliary transmission feature quantity includes an auxiliary total transmission time or an auxiliary total transmission phase difference, and corresponds to the auxiliary positioning module identifier and the terminal device identifier; and determine a second spatial coordinate of the terminal device according to each auxiliary transmission feature quantity and each auxiliary positioning module identifier.

Furthermore, the connection module performs information interaction with the terminal device through the data transceiving module, the auxiliary sending feature and the auxiliary receiving feature of the information are obtained, and the auxiliary sending feature, the auxiliary receiving feature, the corresponding auxiliary positioning module identifier and the corresponding terminal device identifier are sent to the parsing module, so that the parsing module calculates the auxiliary transmission feature quantity according to each auxiliary sending feature quantity and the auxiliary receiving feature, and obtains the second spatial coordinate of the terminal device by combining the auxiliary transmission feature quantity and the auxiliary positioning module identifier, thereby achieving the positioning of the terminal device in a case where the terminal device cannot perform information interaction with the positioning base station.

In a possible implementation, the positioning base station and/or the connection module further includes a communication module; correspondingly, the data transceiving module further includes a communication signal transceiving area; and the communication module is configured to input a communication signal into the data transceiving module, so that the communication signal is sent from the communication signal transceiving area to an air.

Furthermore, by adding the communication module and the communication signal transceiving area of the data transceiving module, the transmission of the communication signal can be achieved. Since the positioning signal and the communication signal are achieved through a unified system, the effect of reducing costs can be achieved.

In a possible implementation, the system further includes: at least one load module, where the load module includes a secondary auxiliary positioning module; one end of the data transceiving module is connected to the positioning module, and the other end of the data transceiving module is connected to the secondary auxiliary positioning module; the load module is configured to perform information interaction with the terminal device through the positioning signal transceiving area of the data transceiving module, so as to generate a secondary auxiliary sending feature and a secondary auxiliary receiving feature of each piece of information, where the secondary auxiliary sending feature includes a secondary auxiliary sending time or a secondary auxiliary sending phase, and the secondary auxiliary receiving feature includes a secondary auxiliary receiving time or a secondary auxiliary receiving phase; and the parsing module is configured to receive the secondary auxiliary sending feature and the secondary auxiliary receiving feature of each piece of information sent by the secondary auxiliary positioning module and/or the terminal device as well as a corresponding secondary auxiliary positioning module identifier and a corresponding terminal device identifier; determine at least one secondary auxiliary transmission feature quantity according to the secondary auxiliary sending feature and the secondary auxiliary receiving feature of each piece of information as well as the corresponding secondary auxiliary positioning module identifier and the corresponding terminal device identifier, where the secondary auxiliary transmission feature quantity includes a secondary auxiliary total transmission time or a secondary auxiliary total transmission phase difference, and corresponds to the secondary auxiliary positioning module identifier and the terminal device identifier; and determine a third spatial coordinate of the terminal device according to each secondary auxiliary transmission feature quantity and each secondary auxiliary positioning module identifier.

Furthermore, by using the load module to perform information transmission and reception with the terminal device, the corresponding secondary auxiliary sending feature and secondary auxiliary receiving feature are obtained, and the spatial coordinate of the terminal device is solved through the secondary auxiliary sending feature, the secondary auxiliary receiving feature as well as the corresponding positioning module identifier, so that the terminal device can be positioned through a system terminal end, thereby increasing the positioning accuracy.

In a possible implementation, the load module further includes: an antenna module, the antenna module is connected to the secondary auxiliary positioning module; and the load module is further configured to perform information interaction with the terminal device through the antenna module.

Furthermore, by adding the antenna module to the load module, the load module can perform information interaction with the terminal device, thereby increasing the positioning range and accuracy.

In a possible implementation, the parsing module is further configured to determine an identifier of a corresponding target positioning signal transceiving area according to each transmission feature quantity and each corresponding positioning module identifier; determine a priority of each transmission feature quantity according to the identifier of the target positioning signal transceiving area corresponding to each transmission feature quantity and the corresponding positioning module identifier; rank the transmission feature quantity in a descending order of priorities, so as to obtain a transmission feature quantity sequence; and determine a spatial coordinate of the terminal device by using the first N transmission feature quantity in the transmission feature quantity sequence, where N is a positive integer.

Furthermore, by determining the positioning module identifier and the identifier of the positioning signal transceiving area corresponding to the transmission feature quantity, the priority of each transmission feature quantity is obtained, and the first N transmission feature quantity with higher priority is selected, so that positioning is more accurate.

In a second aspect, the present application provides a positioning method, which is applied to a positioning system, and the positioning system includes a positioning base station, n data transceiving module and a parsing module, where the positioning base station includes a positioning module, and each data transceiving module includes at least one positioning signal transceiving area, where n is a positive integer; the positioning module is connected to one end of the data transceiving module; and the method includes:
performing, by the positioning module, information interaction with a terminal device through the positioning signal transceiving area of the data transceiving module, so as to generate a sending feature and a receiving feature of each piece of information, where the sending feature includes a sending time or a sending phase, and the receiving feature includes a receiving time or a receiving phase; and
receiving, by the parsing module, the sending feature and the receiving feature of each piece of information sent by the positioning module and/or the terminal device as well as a corresponding positioning module identifier and a corresponding terminal device identifier; determining at least one transmission feature quantity according to the sending feature and the receiving feature of each piece of information as well as the corresponding positioning module identifier and the corresponding terminal device identifier, where the transmission feature quantity includes a total transmission time or a total transmission phase difference, and corresponds to the positioning module identifier and the terminal device identifier; and determining a first spatial coordinate of the terminal device according to each transmission feature quantity and each positioning module identifier.

In the positioning system and method provided in the present application, the corresponding sending feature and receiving feature of each piece of information are obtained by performing information interaction between the positioning base station and the terminal device, the transmission feature quantity is obtained by combining the sending feature and the receiving feature as well as the corresponding positioning module identifier and the corresponding terminal device identifier, and the spatial coordinate of the terminal device is obtained according to the transmission feature quantity and the corresponding positioning module identifier, so that the effect of increasing the positioning accuracy of the terminal device is achieved. In addition, when there is a plurality of transmission feature quantities, the priorities of the transmission feature quantities are ranked and the transmission feature quantity with higher priority is used to further increase the positioning accuracy. The communication module is further added to the positioning base station and/or the connection module, so that it is possible to provide communication services while offering positioning functions, thereby reducing the costs of positioning and communication services.

### BRIEF DESCRIPTION OF THE DRAWINGS

FIG. 1 is a schematic diagram of an application scenario of a positioning system according to an embodiment of the present application.

FIG. 2 is a first schematic structural diagram of a positioning system according to an embodiment of the present application.

FIG. 3 is a second schematic structural diagram of a positioning system according to an embodiment of the present application.

FIG. 4 is a third schematic structural diagram of a positioning system according to an embodiment of the present application.

FIG. 5 is a fourth schematic structural diagram of a positioning system according to an embodiment of the present application.

FIG. 6 is a fifth schematic structural diagram of a positioning system according to an embodiment of the present application.

FIG. 7 is a sixth schematic structural diagram of a positioning system according to an embodiment of the present application.

FIG. 8 is a seventh schematic structural diagram of a positioning system according to an embodiment of the present application.

FIG. 9 is a schematic structural diagram of a connection module according to an embodiment of the present application.

FIG. 10 is a schematic flowchart of a positioning method according to an embodiment of the present application.

FIG. 11 is a schematic structural diagram of an electronic device according to an embodiment of the present application.

### DETAILED DESCRIPTION OF EMBODIMENTS

The exemplary embodiments will be described in detail herein, and the examples thereof are illustrated in the accompanying drawings. When the following description refers to the accompanying drawings, unless otherwise indicated, the same numbers in different drawings represent the same or similar elements. The embodiments described in the following exemplary embodiments do not represent all embodiments consistent with the present application. On the contrary, they are merely examples of apparatus and methods consistent with some aspects of the present application, as detailed in the appended claims.

When using mobile navigation, an important factor for determining the navigation effect is the positioning accuracy, and the positioning accuracy determines the precision of route planning and time prediction.

The current main method for implementing positioning is to perform positioning by using satellite signals. However, in scenarios such as tunnels and subways, due to electromagnetic shielding, the satellite signals cannot be used for positioning. Another solution is to use station signals to perform positioning, and the position of a terminal device is determined by defining base station ranges and selecting an overlapping region of the base station ranges. However, this method is less accurate. Therefore, the positioning accuracy in related art is low and difficulty in solution caused by the multi-path effect at positions with signal shielding such as subways and tunnels.

With regard to the above-mentioned technical problem, the inventor proposes the following technical approach: a positioning base station and a plurality of data transceiving modules are provided, and by expanding a coverage range of a positioning signal through the data transceiving modules, the spatial identification information is increased and the use of positioning base station is reduced, thereby reducing costs and increasing accuracy. Each data transceiving module is provided with a positioning signal transceiving area, the positioning signal is sent to the terminal device through the positioning signal transceiving area, and then a feedback signal returned by the terminal device according to the positioning signal is received, each transmission feature quantity is obtained according to a sending time of the positioning signal and a receiving time of the feedback signal, and a spatial coordinate of the terminal device is determined according to a total time of each data.

The present application is applied to scenarios of positioning the terminal device. It should be noted that user information (including but not limited to user device information, user personal information, etc.) and data (including but not limited to data used for analysis, stored data, displayed data, etc.) involved in the present application are all authorized by the user or sufficiently authorized by all parties, and the collection, use and processing of relevant data must comply with relevant laws, regulations, and standards of relevant countries and regions, with providing a corresponding operation entrance for the user to choose authorization or refusal.

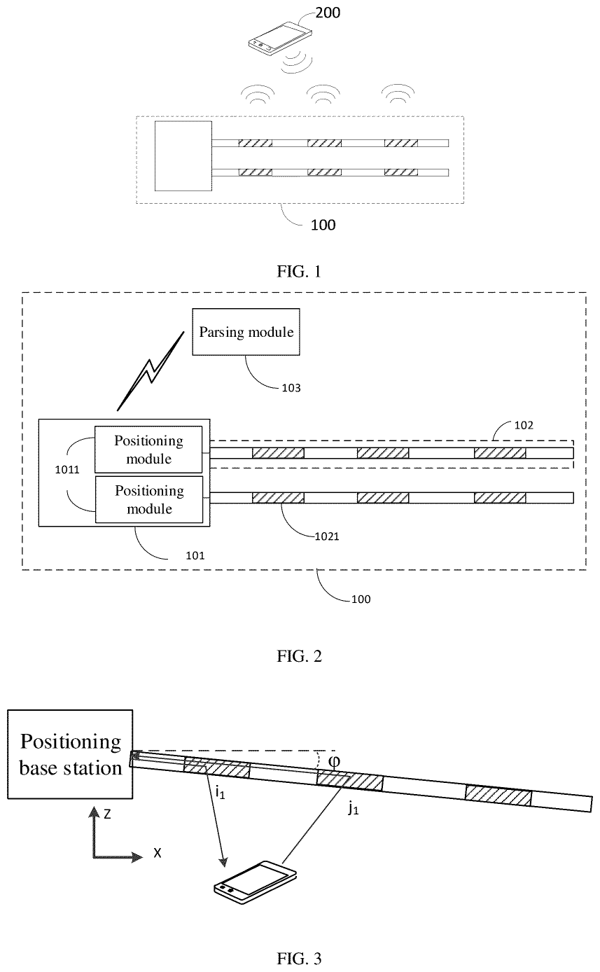

FIG. 1 is a schematic diagram of an application scenario of a positioning system according to an embodiment of the present application. As shown in FIG. 1, in this scenario, a positioning system 100 and a terminal device 200 are included.

The positioning system 100 sends a positioning signal to the outside, so that the terminal device 200 can receive the positioning signal and send feedback information. The positioning system 100 determines a position of the terminal device 200 according to a sending time for sending the positioning signal and a receiving time for receiving each feedback signal. The position of the terminal device 200 may also be sent to the terminal device 200.

It should be understood that the structure in the embodiments of the present application does not constitute a specific limitation of the positioning system. In other feasible embodiments of the present application, the above-mentioned architecture may include more or less components than those shown in the figures, or a combination of certain components, or a splitting of certain components, or a different arrangement of components, which may be specifically determined according to actual application scenarios, and is not limited herein. The components shown in FIG. 1 may be implemented by hardware, software, or a combination of software and hardware.

The technical solution of the present application and how the technical solution of the present application solve the above-mentioned technical problem will be described in the following specific embodiments. The following specific embodiments may be combined with each other, and the same or similar concepts or processes may not be repeated in certain embodiments. The embodiments of the present application will be described below with reference to the accompanying drawings.

FIG. 2 is a first schematic structural diagram of a positioning system according to an embodiment of the present application. As shown in FIG. 2, the positioning system 100 includes:
a positioning base station 101, n data transceiving module 102 and a parsing module 103, where the positioning base station includes a positioning module 1011, and each data transceiving module 102 includes at least one positioning signal transceiving area 1021, where n is a positive integer.

The positioning base station may be a base station with an ability to send a positioning signal. The data transceiving module 102 may be a leaky cable, and correspondingly, the positioning signal transceiving area 1021 may be an embedded hole of the leaky cable. When there are two or more data transceiving modules 102 connected in series, the data transceiving modules 102 connected in series may be connected by using one or more of a jumper wire, a feeder wire and a wire. The positioning signal transceiving area in the data transceiving module 102 may be an embedded hole or an antenna, and a length of the data transceiving module 102 may be 0.5 m to 500 m. The parsing module may be a server, a cluster, or a terminal device as described below.

The positioning module 1011 is connected to one end of the data transceiving module 102.

The connection may be an electrical connection. The other end of the data transceiving module 102 may be connected to a load module, and the load module includes one or more combinations of an antenna module, a combiner module, a positioning module and a load, where the load may be a ground terminal or a resistor, and the positioning module of the load module may also transmit the positioning signal through the antenna module and the data transceiving module, where the load module may be a module at an terminal end of the positioning system.

The positioning module 1011 is configured to perform information interaction with a terminal device through the positioning signal transceiving area of the data transceiving module, so as to generate a sending feature and a receiving feature of each piece of information, where the sending feature includes a sending time or a sending phase, and the receiving feature includes a receiving time or a receiving phase.

Specifically, the information may be input into the data transceiving module, and the data transceiving module sends the information to the air from each positioning signal transceiving area, so that the information reaches the terminal device; and the terminal device sends the information to the air, the positioning signal transceiving area receives the information in the air, and transmits the information back to the positioning module through the data transceiving module to complete the information interaction. In the process of the information interaction, the sending time or the phase of the sent information (i.e., the sending phase) is recorded when the information is sent, and the receiving time or the phase of the received information (i.e., the receiving phase) is recorded when the information is received.

The parsing module is configured to receive the sending feature and the receiving feature of each piece of information sent by the positioning module and/or the terminal device as well as a corresponding positioning module identifier and a corresponding terminal device identifier; determine at least one transmission feature quantity according to the sending feature and the receiving feature of each piece of information as well as the corresponding positioning module identifier and the corresponding terminal device identifier, where the transmission feature quantity includes a total transmission time or a total transmission phase difference, and corresponds to the positioning module identifier and the terminal device identifier; and determine a first spatial coordinate of the terminal device according to each transmission feature quantity and each positioning module identifier.

Specifically, the sending feature, the receiving feature, the corresponding positioning module identifier and the corresponding terminal device identifier may be received through a wired network or a wireless network. The sending feature, the positioning module identifier and the terminal device identifier may be received together, and the receiving feature may also be received together with the positioning module identifier and the terminal device identifier, and a corresponding relationship is formed between each data received together. The method of receiving together may be that each data is in the same data packet or in the same message. Each round of signal transmission and reception can be treated as one interaction, and the use time of one interaction may be the transmission feature quantity, or a time difference can be obtained by making a difference between the time of one information transmission and the time of one information reception, and the time difference is multiplied by two to obtain the transmission feature quantity. In the case where the sending feature and the receiving feature are phases, the transmission feature quantity is the total transmission phase difference. The transmission total phase difference may be calculated by subtracting an information sending phase from an information receiving phase of one information transmission and then multiplying the result by two; or in one interaction, a receiving phase of first information is subtracted by a sending phase of the first information to obtain a first phase difference, a receiving phase of second information is subtracted by a sending phase of the second information to obtain a second phase difference, and the first phase difference and the second phase difference are added to obtain the total transmission phase difference. Since each sending feature has a corresponding positioning module identifier and a corresponding terminal device identifier, and each receiving feature also has a corresponding positioning module identifier and a corresponding terminal device identifier, the transmission feature quantity calculated from the sending feature and the receiving feature corresponding to the same positioning module identifier and terminal device identifier forms a corresponding relationship with this positioning module identifier and this terminal device identifier. The determining the first spatial coordinate of the terminal device according to each transmission feature quantity and each positioning module identifier may be performed by searching for a corresponding positioning module position according to each positioning module identifier and inputting each transmission feature quantity and each positioning module position into a preset formula to obtain the first spatial coordinate of the terminal device. The terminal device identifier may be a serial number or a corresponding number of the terminal device.

In a possible implementation, after obtaining the spatial coordinate of the terminal device, the spatial coordinate may also be sent to the terminal device. The sending method of the first spatial coordinate may be sending the first spatial coordinate by using a contact method corresponding to the serial number of the terminal device, or sending the first spatial coordinate to a number corresponding to the terminal device through a network.

In a possible implementation, the parsing module is the terminal device, and the spatial coordinate are parsed and then displayed on the terminal device. At this time, there is no need to receive the sending feature and the receiving feature sent by the terminal device, and the step of sending the first spatial coordinate to the terminal device does not need to be performed.

As can be seen from the description of the above-mentioned embodiment, in the embodiments of the present application, by providing the positioning base station, the data transceiving module and the parsing module in the positioning system, the positioning module can perform information interaction with the terminal device through the positioning signal transceiving area in the data transceiving module to generate the sending feature and the receiving feature, and the parsing module receives each sending feature, each receiving feature, the corresponding positioning module identifier and the corresponding terminal device identifier, determine at least one transmission feature quantity according to each sending feature and each receiving feature, and determine the spatial coordinate of the terminal device by combining each transmission feature quantity and the received positioning module identifier, thereby improving the positioning accuracy, positioning the spatial coordinate of the terminal device without satellite signals, and overcoming the problem of difficulty in position solution caused by the multi-path effect in conventional leaky cables.

In a possible implementation, the positioning module 1011 is configured to input the positioning signal to the data transceiving module 102, and record the sending time of the positioning signal.

The positioning signal may be input in the form of an electrical signal. The recording the sending time of the positioning signal may be performed by obtaining a time stamp while sending the positioning signal, obtaining and saving the sending time.

The data transceiving module is configured to send the positioning signal from the positioning signal transceiving area to the air, and receive a feedback signal sent by terminal device according to the positioning signal to generate the receiving time, where the feedback signal includes the terminal device identifier.

The air may be in the atmosphere, and may also be an area outside the positioning system. If the positioning signal transceiving area is an antenna, the antenna may send the positioning signal to the outside (outside the positioning system), and if the positioning signal transceiving area is an embedded hole, the embedded hole leaks the positioning signal to the outside. The antenna or the embedded hole also receives signals from the outside, and when the feedback signal sent by the terminal device reaches the antenna or the embedded hole, it will be received by the antenna or the embedded hole. The terminal device may send the feedback signal after receiving the positioning signal, the data transceiving module receives the feedback signal through the antenna or the embedded hole, and the time at which the feedback signal is received can be the receiving time and the method of obtaining the receiving time may be obtaining the time stamp when the feedback signal is received.

The positioning module is configured to receive the feedback signals sent by the data transceiving module, record each receiving time corresponding to each feedback signal, and send each sending time, each receiving time, the corresponding positioning module identifier and the corresponding terminal device identifier to the parsing module.

Each receiving time may be obtained by obtaining the time stamp when the feedback signal is received. The corresponding positioning module identifier may be an identifier of the positioning module itself, and the terminal device identifier may be a terminal device identifier contained in the feedback signal. The sending time, the receiving time, the corresponding positioning module identifier and the corresponding terminal device identifier may be sent through a wired network or a wireless network, and a sending format may be a data packet, a message, a text, etc.

The parsing module is configured to determine each corresponding total transmission time according to each sending time, each receiving time, the corresponding positioning module identifier and the corresponding terminal device identifier.

After receiving the feedback signal, the data transceiving module may transmit the feedback signal to both ends of the data transceiving module, so as to transmit the feedback signal to the positioning base station. The determining each corresponding total transmission time according to each sending time and each receiving time may be performed by obtaining the corresponding total transmission time by subtracting the sending time from each receiving time. If a transmission direction of the information is one-way and single-trip, that is, the information is sent by the terminal device and received by the positioning module, or the information is sent by the positioning module and received by the terminal device, the time difference obtained by subtracting the sending time from the receiving time is multiplied by two to obtain the total transmission time. Since it is necessary to calculate a position of a certain terminal device and it is necessary to use the sending feature and receiving feature generated by the interaction between the terminal device and a certain positioning module, the sending time and the receiving time corresponding to the same positioning module identifier and terminal device identifier need to be used in the process of calculating the total transmission time.

The data transceiving module is configured to receive a positioning request transmitted by the terminal device through the positioning signal transceiving area, where the positioning request includes a sending time of the positioning request and a corresponding terminal device identifier.

Specifically, the positioning request is similar to the above-mentioned feedback signal and is actively sent by the terminal device, the sending time of the positioning request can be obtained by obtaining a time stamp when the terminal device sends the positioning request, and the terminal device identifier can be an identifier of the terminal device sending the positioning request.

The positioning module is configured to receive the positioning request sent by the data transceiving module, record a receiving time of each positioning request, and send the sending time of each positioning request, the receiving time of each positioning request, the corresponding positioning module identifier and the corresponding terminal device identifier to the parsing module.

Specifically, the recording the receiving time of each positioning request may be performed by obtaining a time stamp at the same time as receiving the positioning request each time to obtain the receiving time of the positioning request. The sending time, the receiving time, the corresponding positioning module identifier and the corresponding terminal device identifier may be sent through a wired or wireless network.

The parsing module is configured to determine each corresponding total transmission time according to the sending time of each positioning request, the receiving time of each positioning request, the corresponding positioning module identifier and the corresponding terminal device identifier.

Specifically, the sending time of the positioning request is subtracted from the receiving time of the positioning request to obtain a one-way transmission time, and the one-way transmission time is multiplied by two to obtain the total transmission time. The total transmission time corresponds to the positioning module identifier and the terminal device identifier.

The data transceiving module is configured to receive a positioning request transmitted by the terminal device through the positioning signal transceiving area, wherein the positioning request comprises a sending time of the positioning request and a corresponding terminal device identifier; the positioning module is configured to receive each positioning request sent by the data transceiving module and record a receiving time of each positioning request, and input a positioning signal to the data transceiving module and record a sending time of each positioning signal; the data transceiving module is configured to send the positioning signal from the positioning signal transceiving area to an air, receive a feedback signal sent by the terminal device according to the received positioning signal, and send the feedback signal to the positioning module, where the feedback signal includes a sending time of the feedback signal and a corresponding terminal device identifier; the positioning base station is configured to receive each feedback signal sent by the data transceiving module and record each receiving time corresponding to each feedback signal, and send the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier to the parsing module; and the parsing module is configured to determine each total transmission time according to the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier.

Specifically, the determining the total transmission time according to the receiving time of each feedback signal, the sending time of the feedback signal, the receiving time of each positioning request, the sending time of each positioning signal, the terminal device identifier corresponding to each positioning request, the terminal device identifier corresponding to each feedback signal and the positioning module identifier may be obtaining a feedback duration by subtracting the sending time of the feedback signal from the receiving time of the feedback signal corresponding to the same terminal device identifier and positioning module identifier, subtracting the sending time of the positioning signal from the receiving time of the positioning request to obtain a sending duration, and adding the feedback duration and the sending duration to obtain the total transmission time. The embodiment of the present application is similar to the method in calculating the transmission time in the above-mentioned embodiments, and will not be repeated herein. The method in which the parsing module receives the sending feature and the receiving feature of each piece of information sent by the terminal device and calculates the transmission feature quantity is similar to the process in which the parsing module receives the sending feature and the receiving feature of each piece of information sent by the positioning module and calculates the transmission feature quantity, and will not be repeated herein.

As can be seen from the description of the above-mentioned embodiment, in the embodiments of the present application, the positioning base station receives and sends the signal through the positioning signal transceiving area of the data transceiving module, and records the receiving and sending time of the signal, so as to calculate the transmission feature quantity, thereby facilitate determining the spatial coordinate of the terminal device according to the transmission feature quantity, and achieving the effect of improving the positioning accuracy and positioning the spatial coordinate of the terminal device without the satellite signals.

In a possible implementation, a calculation method of the total transmission phase difference is similar to that of the total transmission time, and may be recording a sending phase of the signal when the positioning base station sends the signal to the terminal device, and writing the sending phase into the signal. The terminal device collects a receiving phase of the received signal when receiving the signal and reads the sending phase in the signal; and subtracts the sending phase from the receiving phase to obtain a one-way phase difference, and multiplies the one-way phase difference by two to obtain the total transmission phase difference. It may also be recording the sending phase of the signal when the terminal device sends the signal to the positioning base station, and writing the sending phase into the signal. The positioning base station reads a receiving phase of the collected signal when receiving the signal and reads the sending phase in the signal; and subtracts the sending phase from the receiving phase to obtain a one-way phase difference, and multiplies the one-way phase difference by two to obtain the total transmission phase difference. When calculating the total transmission phase difference, the adopted sending phase or receiving phase also needs to correspond to the same positioning module identifier and terminal device identifier. Another possible implementation is as follows: resending the signal after the signal is received at any side of the positioning base station and the terminal device, and when the signal is sent, the phase of the sent signal needs to be synchronous with that of the received signal.

In a possible implementation, at the terminal end of the positioning system, one end of the data transceiving module can be connected to the positioning base station, and the other end is connected to the load module, including one or more combinations of a wave absorbing module, an antenna module, a combiner module and a positioning module. The positioning module of the load module may also be able to transmit the positioning signal through the antenna module and the data transceiving module.

In a possible implementation, determining each corresponding transmission feature quantity according to the sending time and each receiving time specifically includes:
reading a positioning signal receiving time and a feedback signal sending time in each feedback signal, subtracting the sending time of each positioning signal from each positioning signal receiving time to obtain each first time difference; subtracting the sending time of each feedback signal from each feedback signal receiving time to obtain each second time difference; and adding each first time difference and each second time difference to obtain each transmission feature quantity.

The positioning signal receiving time may be a time recorded when the terminal device receives the positioning signal, and the feedback signal sending time may be a time recorded when the terminal device sends the feedback signal.

For example, the positioning module sends a pulse signal with a request type at a time Tₐ₁ on the time stamp thereof, the terminal device receives the signal at the time T_{b1} on the time stamp thereof, and then after the positioning signal is subjected to certain processing means, the terminal device transmits a signal of a response type at a time T_{b2}, which is received by the positioning module at the time Tₐ₂ on its own time stamp.

When there is only one transmission and reception response, a round-trip time between the positioning module and the terminal device is calculated as: T=2×(T_{b1}−Tₐ₁), and at this time, the positioning module needs to be strictly synchronized with the terminal device. When there are at least two transmission and reception responses, the round-trip time between the positioning module and the terminal device is calculated as: T=(Tₐ₁−Tₐ₂)−(T_{b1}−T_{b2}). A total round-trip time minus a round-trip time transmitted in the data transceiving module is a round-trip time transmitted in air, and the round-trip time transmitted in air multiplied by the speed of light c can determine a total distance transmitted in the air of two responses between the positioning module and the terminal device.

Correspondingly, a round-trip phase difference between the positioning module and the terminal device is calculated as: Ψ=2×(Ψb1−Ψa1), and at this time, the positioning module need to be strictly synchronized with the terminal device. When there are at least two transmission and reception responses, the round-trip phase difference between the positioning module and the terminal device is calculated as: Ψ=(Ψa1−Ψa2)−(Ψb1−Ψb2). A total round-trip phase difference minus a round-trip phase difference transmitted in the data transceiving module is a round-trip phase difference transmitted in air, and the round-trip phase difference transmitted in air multiplied by a wavelength divided by 2 π can determine a total distance transmitted in the air of two responses between the positioning module and the terminal device.

In a possible implementation, the parsing module is configured to obtain the number of the transmission feature quantity, and determine the first spatial coordinate of the terminal device according to the number of the transmission feature quantity, each positioning module identifier and each transmission feature quantity.

Specifically, the obtaining the number of the transmission feature quantity may be performed by setting an initial number of transmission time as 0 after sending the positioning signal, increasing the number by 1 for each feedback signal received, and determining the number after a preset time as the number of the transmission feature quantity. The determining the first spatial coordinate of the terminal device according to the number of the transmission feature quantity, each positioning module identifier and each transmission feature quantity may be searching for a positioning module position corresponding to each positioning module identifier, and determining the first spatial coordinate of the terminal device according to different numbers of the transmission feature quantity and using the corresponding number of the transmission feature quantity and each positioning module position.

As can be seen from the description of the above-mentioned embodiment, in the embodiments of the present application, the spatial coordinate of the terminal device is obtained by combining the number of the transmission feature quantity, the positioning module identifier, and each transmission feature quantity, thereby achieving the effect of performing positioning without the satellite signals.

In a possible implementation, the parsing module is configured to: if the number of the transmission feature quantity is greater than or equal to 3, determine a target position of each target positioning module according to the positioning module identifier, where the target positioning module is a positioning module that performs signal transmission and reception; determine an identifier of each corresponding target positioning signal transceiving area according to each transmission feature quantity and the corresponding positioning module identifier, where the target positioning signal transceiving area includes a positioning signal transceiving area through which each piece of information passes; search for each piece of target structural information corresponding to the identifier of each target positioning signal transceiving area; and determine the first spatial coordinate of the terminal device according to each piece of target structural information, the target position of each target positioning module and each transmission feature quantity.

Specifically, the information in the embodiments of the present application includes the positioning signal, the feedback signal, and the positioning request in above-mentioned embodiments. The determining the target position of each target positioning module according to the positioning module identifier may be performed by searching for a preset corresponding relationship between an identifier and a position according to the positioning module identifier, so as to obtain the position of the positioning module corresponding to the positioning module identifier, where the corresponding relationship between the identifier and the position may be calibrated by workers according to experimental data or actual measurement data. The corresponding relationship between the transmission feature quantity and the positioning module identifier may be generated when the transmission feature quantity is calculated using the sending feature and the receiving feature corresponding to the positioning module identifier and the terminal device identifier. Since the sending feature and the receiving feature corresponding to the same group of the positioning module identifier and the terminal device identifier are used to calculate the transmission feature quantity, the transmission feature quantity corresponds to this group of the positioning module identifier and the terminal device identifier. The determining the identifier of each corresponding target positioning signal transceiving area according to each transmission feature quantity and the corresponding positioning module identifier may be searching for a corresponding relationship between a time range corresponding to the positioning module identifier and the target positioning signal transceiving area, and each positioning module identifier corresponds to different corresponding relationship between a preset time range and the target positioning signal transceiving area. A plurality of preset time ranges are read to search for each target time range to which each transmission feature quantity belongs, and the corresponding relationship between the preset time range corresponding to the positioning module identifier and the identifier of positioning signal transceiving area is searched for according to each target time range, so as to obtain the identifier of the target positioning signal transceiving area corresponding to each transmission feature quantity. The searching for each piece of target structural information corresponding to the identifier of each target positioning signal transceiving area may be performed by searching for target structural information corresponding to the identifier of the target positioning signal transceiving area in the preset corresponding relationship between the identifier of the positioning signal transceiving area and the target structural information, where the corresponding relationship may be pre-calibrated by workers through experimental data or measurement data, and which may be in the format of a table, a text, etc. The determining the first spatial coordinate of the terminal device according to each piece of target structural information, the target position of each target positioning module and each transmission feature quantity may be performed by inputting each piece of target structural information, the target position of each target positioning module and each transmission feature quantity into a preset formula to obtain the first spatial coordinate.

The each of above-mentioned corresponding relationships may be pre-calibrated through experiments, and the storage format thereof may be stored in a format such as a table, a text, etc.

As can be seen from the above description of the above-mentioned embodiment, in the embodiments of the present application, in a case where the number of the transmission feature quantity is greater than or equal to 3, the target position of each target positioning module is determined according to the positioning module identifier, the identifier of each corresponding target positioning signal transceiving area is determined according to each transmission feature quantity and the corresponding positioning module identifier, each corresponding target structural information is obtained by searching for a corresponding relationship through the identifier of each corresponding target positioning signal transceiving area, and the spatial coordinate of the terminal device is obtained according to each piece of target structural information, the target position of each target positioning module and each transmission feature quantity, thereby achieving the effect of determining the spatial coordinate of the terminal device by combining the structural information of the positioning signal transceiving area and each transmission feature quantity, without using the satellite signals.

In a possible implementation, the target structural information includes a target angle of the target positioning signal transceiving area and a target distance from the positioning base station to the target positioning signal transceiving area, where the target positioning module is a positioning module that performs information interaction.

The target distance may include a length of the data transceiving module passing from the target positioning module of the positioning base station to the target positioning signal transceiving area, and may further include a distance from a signal transceiving point to an input port. The target position may include a three-dimensional coordinate of the target positioning module. The data transceiving module where the target positioning signal transceiving area is located is determined to be the target data transceiving module, and the target angle may include angles between the target positioning signal transceiving area and horizontal and vertical directions, an angle between the target positioning signal transceiving area and an extending direction of the data transceiving module, angles between the target data transceiving module and horizontal and vertical directions, and an angle between the target data transceiving module and an extending direction of the positioning system.

The parsing module is configured to: search for a preset corresponding relationship between the transmission feature quantity, the positioning module identifier and a time error/phase difference error according to each transmission feature quantity and the positioning module identifier, so as to obtain each target error; and input each target position, each target angle, each target distance, each target time error/phase difference error and each transmission feature quantity into a preset formula, so as to obtain the first spatial coordinate of the terminal device.

Specifically, the corresponding relationship between the transmission feature quantity, the positioning module identifier and the error may be pre-calibrated through experiments, and the target error may also be obtained by searching for a preset corresponding relationship between the positioning signal transceiving area and the error according to the target positioning signal transceiving area.

FIG. 3 is a second schematic structural diagram of a positioning system according to an embodiment of the present application. As shown in FIG. 3, the first spatial coordinate of the terminal device is obtained by inputting each target position, each target angle, each target distance, each target error, and each total transmission time into a preset formula as follows:

In the above formula, x, y and z respectively denote a horizontal coordinate, a vertical coordinate and a vertical coordinate of the terminal device, x₁, y₁ and z₁ respectively denote a horizontal coordinate, a vertical coordinate and a vertical coordinate of a target positioning module (a target position), l denotes a length (a target distance), θ is an angle between a data transceiving module or a posit signal transceiving area and the z-axis in the positive direction or an angle with a vertical plane, φ is an angle, as viewed from the positive z-axis, turned from the x-axis in a clockwise direction to a projection of a cable module or a projection of the positioning area on the x₀y plane, and θ and φ belong to the target angle. In the case that the connection method of the data transceiving module includes directly connection to the positioning base station (the primary data transceiving module in the following) and indirectly connection to the positioning base station (the secondary data transceiving module), the subscripts e₁, u₁ represent a data transceiving module that is directly connected to the positioning base station, and f₁, v₁ represent a data transceiving module that is indirectly connected to the positioning base station, i₁, j₁, denote the target positioning signal transceiving area, Δr, Δy, Δz denote a position error of the connection between the data transceiving module. T denotes a total transmission time, Δt denotes an error (the target error) generated by various components, Δtᵢ₁ denotes an error generated by various components when the signal passes through the target positioning signal transceiving area i₁, that is, the target error corresponding to the target positioning signal transceiving area i₁, Δtⱼ₁ denotes an error generated by various components when the signal passes through the target positioning signal transceiving area j₁, that is, the target error corresponding to the target positioning signal transceiving area j₁, and a denotes a transmission speed of the positioning signal in the data transceiving module. m_{i1g} denotes the number of a primary data transceiving module connected between the positioning signal transceiving area i₁ and the positioning base station, m_{i1b} denotes the number of a secondary data transceiving module connected between the positioning signal transceiver region i₁ and the positioning base station, m_{j1g} denotes the number of a primary data transceiving module connected between the positioning signal transceiving area j₁ and the positioning base station, and m_{j1b} denotes the number of a secondary data transceiving module connected between the positioning signal transceiver region j₁ and the positioning base station. The “1” in the subscript of each variable indicates the positioning module ₁, for example, x₁, y₁, z₁ are the horizontal coordinate, the vertical coordinate, and the vertical coordinate of the positioning module 1, respectively. In the case where there is only one positioning module that performs signal transmission and reception, the signal can be sent and received for many times, so as to obtain a plurality of equations, and the spatial coordinate is obtained by doing simultaneous equations and solving the same. In this case, in the newly obtained formula, the above i and j should be replaced with the identifiers of new positioning signal transceiving areas, for example, if the new target positioning signal transceiving areas are p and q, and the formula is as follows:

If the signal transmission and reception is performed again, more equations may also be obtained, so that a system of equations can be jointly built by performing the signal transmission and reception several times, and the embodiments of the present application does not specifically limit a number of transmission and reception times.

In a possible implementation, the first spatial coordinate of the terminal device is obtained by inputting each target position, each target angle, each target distance, each target error and each transmission total phase difference into a preset formula:

In the formula, Ψ denotes a phase, c is an electromagnetic wave transmission speed in the air, λ is a wavelength of the positioning signal in the air, λ_{ce}_{₁} (e₁=0, 1, 2, . . . , mᵢ_{_{1g}}) is a wavelength of the positioning signal in the ej-th first data transceiving module in the positioning module 1, Δ_{cf}_{₁} (e₁=0, 1, 2, . . . , mᵢ_{_{1g}}) is a wavelength of the positioning signal in the f₁-th second data transceiving module connected to the positioning module 1, Δ_{cu}_{₁} (e₁=0, 1, 2, . . . , mᵢ_{_{1g}}) is a wavelength of the positioning signal in the u₁-th first data transceiving module of the positioning module 1, Δ_{cv}_{₁} (e₁=0, 1, 2, . . . , mᵢ_{_{1g}}) is a wavelength of the positioning signal in the vy-th first data transceiving module of the positioning module 1, λ_{ci}_{₁} is a wavelength of the positioning signal in the positioning signal transceiving area i₁, λ_{cj}_{₁} is a wavelength of the positioning signal in the positioning signal transceiving area j₁, and ΔΨᵢ₁ and ΔΨⱼ₁ belong to the phase difference error. The meaning of other parameters is the same as that of the above-mentioned formula, and will not be repeated herein.

When i₁=j₁, the positioning module 1 and the terminal device achieve at least one transmission and reception response process through the same transmission path, that is, they both pass through the same positioning signal transceiving area on the data transceiving module through the transmission path. When there is only one transmission and reception response, T is twice of a data transmission and reception time between the positioning base station and the terminal device.

When i₁≠j₁, the positioning module 1 and the terminal device achieve at least two transmission and reception response processes through different transmission paths, that is, they both pass through different positioning signal transceiving areas on the data transceiving module through the transmission paths. T is a total data transmission and reception time between the positioning base station and the terminal device.

The position error and the transmission speed may be pre-calibrated through experiments.

In a possible implementation, if the positioning system does not include a data transceiving module that is indirectly connected to the positioning base station, then the items related to the second data transceiving module in the formula can be removed.

As can be seen from the description of the above-mentioned embodiment, in the embodiments of the present application, by searching for the corresponding relationship between the transmission feature quantity, the positioning module identifier and the error, each target error corresponding to each transmission feature quantity is obtained, and each target position, each target angle, each target distance, each target error and each transmission feature quantity are input into the preset formula, so as to obtain the first spatial coordinate of the terminal device, thereby obtaining a three-dimensional coordinate of the terminal device through the transmission feature quantity, and enabling the positioning of the terminal device in complex environments.

In a possible implementation, the parsing module is configured to: if the number of the transmission feature quantity is 1 or 2, obtain a preset reference coordinate; determine a target position of each target positioning module according to the positioning module identifier, where the target positioning module is a positioning module that performs signal transmission and reception; determine an identifier of each corresponding target positioning signal transceiving area according to each transmission feature quantity and the corresponding positioning module identifier, where the target positioning signal transceiving area is a positioning signal transceiving area that sends the positioning signal or receives the feedback signal; search for each piece of target structural information corresponding to the identifier of each target positioning signal transceiving area; and determine the first spatial coordinate of the terminal device according to the preset reference coordinate, each piece of target structural information, the target position of each target positioning module and each transmission feature quantity.

Specifically, if the number of the transmission feature quantity is 1, a preset vertical coordinate y and a preset vertical coordinate z are read; and if the number of the transmission feature quantity is 2, any one of the preset vertical coordinate y and the preset vertical coordinate z is read. The read preset reference coordinates are used to replace the variables to be solved in the formula, and the first spatial coordinate is calculated by inputting each piece of target structural information, each target position and each transmission feature quantity are input into the replaced formula.

The vertical coordinate may be a coordinate that is parallel to the horizontal plane and perpendicular to the extending direction of the positioning system, and an upright coordinate may be a coordinate that is perpendicular to the horizontal plane. Other parts of the embodiment of the present application are similar to the above-mentioned embodiments where the number of the transmission feature quantity is greater than or equal to 3, and will not be repeated herein.

As can be seen from the description of the above-mentioned embodiment, in the embodiments of the present application, in a case where the number of receiving times of a feedback signal is limited so that the total transmission time is 1 or 2, the preset reference coordinate is read, the target position of the target positioning module is determined through the positioning module identifier, and each corresponding target positioning signal transceiving area is determined by combining each transmission feature quantity and the corresponding positioning module identifier, each piece of target structural information corresponding to the identifier of each corresponding target positioning signal transceiving area is searched for, and the spatial coordinate of the terminal device is determined through the preset reference coordinate, each piece of target structural information, each target position and each transmission feature quantity, so that in the case where the receiving number of times of the feedback signal is limited, the positioning of the terminal device can achieve the effects of reducing the calculation amount, reducing positioning time and reducing positioning costs in scenarios with relatively fixed coordinates, such as a tunnel.

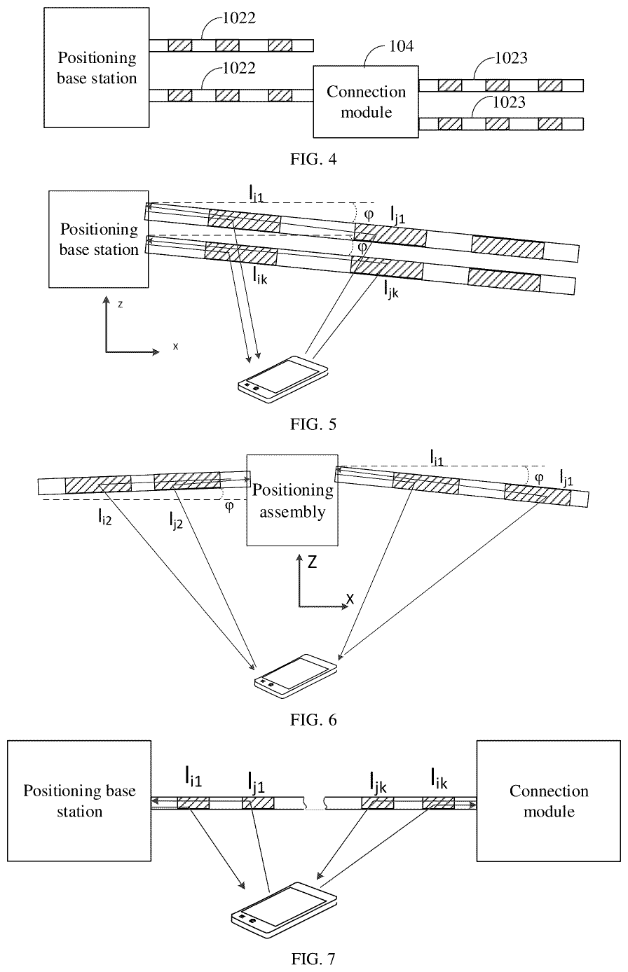

FIG. 4 is a third schematic structural diagram of a positioning system according to an embodiment of the present application. The data transceiving module 102 includes a first data transceiving module 1022 and a second data transceiving module 1023. The system further includes at least one connection module 104. The second data transceiving module is connected to the connection module.

One end of the first data transceiving module 1022 is connected to the positioning module 1011, and the other end of the first data transceiving module 1022 is connected to one end of the connection module 104.

The connection module is configured to receive a positioning signal input by the positioning base station through the first data transceiving module and input the positioning signal into the second data transceiving module, so that the positioning signal is sent to an air through the second data transceiving module; and receive a feedback signal input by the terminal device through the second data transceiving module and send the feedback signal to the positioning base station through the first data transceiving module.

Specifically, the connection module continuously receives an electrical signal from the first data transceiving module and the second data transceiving module, and inputs the electrical signal transmitted on one side to the other side. The second data transceiving module also transmits the positioning signal to the outside through the positioning signal transceiving area.

In a possible implementation, the connection module may further be connected to an external power supply, so as to achieve current and signal enhancement. In the case of the embodiments of the present application, the connection module does not include a positioning module, and does not send the positioning signal.

As can be seen from the description of the above-mentioned embodiment, in the embodiments of the present application, by providing the connection module and connecting it to the first data transceiving module and the second data transceiving module respectively, the signal input by the first data transceiving module is output to the second data transceiving module, so that the positioning signal is sent to the air through the second data transceiving module, and the feedback signal input by the terminal device through the second data transceiving module is received, and the feedback signal is input into the first data transceiving module, so that at least two data transceiving modules are connected in series, and information intercommunication is achieved, thereby achieving the effect of prolonging signal coverage range and positioning range of the positioning system.

In a possible implementation, the data transceiving module includes a first data transceiving module and a second data transceiving module; the system further includes: at least one connection module; and the connection module includes an auxiliary positioning module.

The auxiliary positioning module can send the positioning signal, and in this case, the first data transceiving module and the second data transceiving module may not be conductive with each other, and the connection module is no longer responsible for conducting signals in the first data transceiving module and the second data transceiving module with each other.

One end of the first data transceiving module is connected to the positioning module, and the other end of the first data transceiving module is connected to the auxiliary positioning module; the second data transceiving module is connected to the auxiliary positioning module.

The embodiment of the present application is similar to the above-mentioned embodiments, and will not be repeated herein.

The connection module is configured to perform information interaction with the terminal device through a positioning signal transceiving area of the first data transceiving module and/or the second data transceiving module, so as to generate an auxiliary sending feature and an auxiliary receiving feature of each piece of information, where the auxiliary sending feature includes an auxiliary sending time or an auxiliary sending phase, and the auxiliary receiving feature includes an auxiliary receiving time or an auxiliary receiving phase.

Specifically, the process of generating the auxiliary sending feature and the auxiliary receiving feature is similar to the above-mentioned process of generating the sending feature and the receiving feature, and will not be repeated herein.

The method of sending each auxiliary transmission feature quantity to the parsing module may be sending each auxiliary transmission feature quantity directly through a network or a wire, and in the case where the connection module includes the positioning base station, each auxiliary transmission feature quantity may also be sent to the parsing module through a communication base station. In the embodiments of the present application, the function and operation mode of the connection module are similar to those of the positioning base station, and will not be repeated herein again.

The parsing module is configured to receive the auxiliary sending feature and the auxiliary receiving feature of each piece of information sent by the auxiliary positioning module and/or the terminal device as well as a corresponding auxiliary positioning module identifier and a corresponding terminal device identifier; determine at least one auxiliary transmission feature quantity according to each auxiliary sending feature and each auxiliary receiving feature as well as the corresponding auxiliary positioning module identifier and the corresponding terminal device identifier, where the auxiliary transmission feature quantity includes an auxiliary total transmission time or an auxiliary total transmission phase difference, and corresponds to the auxiliary positioning module identifier and the terminal device identifier; and determine a second spatial coordinate of the terminal device according to each auxiliary transmission feature quantity and each auxiliary positioning module identifier.

In the embodiments of the present application, the identifier of the auxiliary positioning module is similar to the positioning module identifier, and the method by which the parsing module determines the second spatial coordinate is similar to the method of determining the first spatial coordinate in the above-mentioned embodiments, and the method of sending the second spatial coordinate is similar to the method of sending the first spatial coordinate, which will not be repeated herein.

As can be seen from the description of the above-mentioned embodiment, in the embodiments of the present application, the connection module performs information interaction with the terminal device through the data transceiving module, the auxiliary sending feature and the auxiliary receiving feature of the information are obtained, and the auxiliary sending feature, the auxiliary receiving feature, the corresponding auxiliary positioning module identifier and the corresponding terminal device identifier are sent to the parsing module, so that the parsing module calculates the auxiliary transmission feature quantity according to each auxiliary sending feature quantity and the auxiliary receiving feature, and obtains the second spatial coordinate of the terminal device by combining the auxiliary transmission feature quantity and the auxiliary positioning module identifier, thereby achieving the positioning of the terminal device in a case where the terminal device cannot perform information interaction with the positioning base station.

FIG. 5 is a fourth schematic structural diagram of a positioning system according to an embodiment of the present application. As shown in FIG. 5, the positioning base station may receive the feedback signal or send the positioning signal through a plurality of positioning data transceiving modules and perform positioning. In conjunction with FIG. 5, the spatial coordinate of the terminal device can also be calculated by building a simultaneous system of equations, and each target position, each target angle, each target distance, each target error and each total transmission time are input into the system of equations to obtain the spatial coordinate of the terminal device; and the system of equations is as follows:

or, the spatial coordinate of the terminal device is obtained by inputting each target position, each target angle, each target distance, each target error and each transmission total phase difference into the following system of equations:
in the above formula, eₖ and uₖ denote the data transceiving module directly connected to the positioning base station, and fₖ and vₖ denote the data transceiving module indirectly connected to the positioning base station, where k is an integer greater than or equal to 1, m_{ikg} denotes the number of a first data transceiving module connected between the positioning signal transceiving area iₖ and the positioning base station, m_{ikb} denotes the number of a second data transceiving module between the positioning signal transceiving area iₖ and the positioning base station, m_{jkg} indicates the number of the first data transceiving module connected between the positioning signal transceiving area jₖ and the positioning base station, m_{jkb} denotes the number of the second data transceiving module between the positioning signal transceiving area jₖ and the positioning base station. k is used to indicate the “k-th” to distinguish various parameters in combination with the above-mentioned other subscripts, which may be the k-th positioning module that receives the positioning signal. The meanings of other parameters are similar to those of other formulas in the present application, will not be repeated herein.

In a possible implementation, the positioning base station or the connection module is connected to two data transceiving modules, and the spatial coordinate of the terminal device are calculated by inputting each target position, each target angle, each target distance, each target error and each total transmission time into the following system of equations:

or, the spatial coordinate of the terminal device is obtained by inputting each target position, each target angle, each target distance, each target error and each transmission total phase difference into the following system of equations:

In any equation in the above system of equations, when i₁=j₁ or i₂=j₂, the positioning base station and the terminal device achieve at least one transmission and reception response process through the same transmission path, that is, they both pass through the same positioning signal transceiving area on the data transceiving module through the transmission path. When there is only one transmission and reception response, Tₖ is twice of the time of sending the positioning signal to the terminal device or the time of sending the feedback signal to the positioning base station.

In any equation in the above system of equations, when i₁≠j₁ or i₂≠j₂, the positioning base station and the terminal device achieve at least two transmission and reception response processes through different transmission paths, that is, they both pass through different positioning signal transceiving areas on the data transceiving module through the transmission paths. Tₖ is the total transmission time.

The above-mentioned two system of equations both perform the signal transmission and reception process once through the two positioning modules, and the preset reference coordinate can be read to replace any one of x, y, and z in the system of equations, so that the system of equations can be solved, and the signal transmission and reception is performed again to obtain more equations, so that the system of equations can be solved.

FIG. 6 is a fifth schematic structural diagram of a positioning system according to an embodiment of the present application. As shown in FIG. 6, the positioning base station or the connection module is determined as a positioning assembly, and the positioning signal transceiving modules are connected on both sides of the positioning assembly. The spatial coordinates of the terminal device can be solved by using a similar method of solving the system of equations.

When the spatial coordinate of the terminal device is calculated through one data transmission and reception process of the positioning base station and one data transmission and reception process of the connection module, the following system of equations may be used:

or, when the terminal device and the positioning base station interact with each other, the sum of the relative positions of the terminal device and the positioning signal transceiving areas iₖ and jₖ is equal to the total transmission phase of two paths in air multiplied by the wavelength divided by 2 π. When the terminal device and the connection module interact with each other, the relative position of the positioning signal transceiving areas i₂ and j₂ is equal to the total transmission phase of the two paths in air multiplied by the wavelength divided by 2 π. The relative position (x, y) of the terminal device and the positioning base station can be obtained through the following system of equations:

where, lₑ_{₁}(e₁=0,1,2, . . . , mᵢ_{_{1g}};) is a length of the e₁-th primary data transceiving module that connects to the positioning signal transceiving area i₁ and the positioning module 1, and l_{f}_{₁}(f₁=0,1,2, . . . , mᵢ_{_{1b}};) is a length of the f₁-th secondary data transceiving module that connects to the positioning signal transceiving area i₂ and the positioning module 1. m_{i1g} denotes the number of a primary data transceiving module connected between the positioning signal transceiving area i₂ and the positioning base station, m_{i1b} denotes the number of a secondary data transceiving module between the positioning signal transceiving area i₁ and the positioning base station, m_{j1g} denotes the number of a primary data transceiving module connected between the positioning signal transceiving area j₁ and the positioning base station, and mjib denotes the number of a secondary data transceiving module between the positioning signal transceiving area j₁ and the positioning base station. m_{i2g} denotes the number of a primary data transceiving module connected between the positioning signal transceiving area i₂ and the positioning base station, m_{i2b} denotes the number of a secondary transceiving module between the positioning signal transceiver region i₂ and the positioning base station, m_{j2g} denotes the number of a primary data transceiving module connected between the positioning signal transceiver region j₂ and the positioning base station, and m_{j2b} denotes the number of a secondary data transceiving module between the positioning signal transceiving area j₂ and the positioning base station. The data transceiving module k (k=1 or 2, and the same applies for k hereinafter) is connected to the positioning module port at an initial position of (xₖ, yₖ, Zₖ), a time delay for the positioning signal to be transmitted from the positioning module k to the positioning signal transceiving area port is Δtₖ, and a phase difference for the positioning signal to be transmitted from the positioning module k to the positioning signal transceiving area port is ΔΨₖ. Tₖ is twice of the two-path transmission feature quantity or the single-path transmission feature quantity between the positioning module k and the positioning module p, and ΔΨₖ is twice of the two-path transmission total phase or the single-path transmission total phase between the positioning modules k and p. c is an electromagnetic wave transmission speed in the air, λ is a wavelength of the positioning signal in the air, λ_{c1} is a wavelength of the positioning signal in the data transceiving module, a is a transmission rate of the positioning signal in the data transceiving module, and θ is an angle between the data transceiving module in the x0z plane and the z axis; and φ is an angle between the data transceiving module in the x0y plane and the x axis.

When i₁=j₁ and i₂=j₂, at this time, the positioning signal transceiving area iz and the positioning signal transceiving area j are in the same data transceiving module, and the positioning module i₂ and the positioning module j₂ are the same positioning module, but the positioning signal transceiving areas i₁ and j₁ and the positioning signal transceiving areas i₂ and j₂ cannot be the same positioning signal transceiving area. The positioning module 1 or the positioning module 2 and the terminal device achieve at least one transmission and reception response process through the same transmission path, that is, they all pass through the same positioning signal transceiving area on the positioning system through the transmission path. When there is only one transmission and reception response, T₁ and T₂ are twice of the transmission feature quantity of a single path between the two positioning modules.

When i₁+j₁ and i₂=j₂ or i₁=j₁ and i₂+j₂, the positioning signal transceiving areas i₂, j₂ may be the same positioning signal transceiving area as one of the positioning signal transceiver transceiving area i₁ and j₁, or the positioning signal transceiving areas i₁, j₁ may be the same positioning signal transceiving area as one of the positioning signal transceiver transceiving area i₂ and j₂. The two positioning modules in the same positioning signal transceiving area achieve at least one transmission and reception response process through the same transmission path between, that is, they all pass through the same positioning signal transceiving area on the positioning system through the transmission paths. When there is only one transmission and reception response, T₁ or T₂ is twice of the single-path transmission feature quantity between two positioning modules. The two positioning modules in two different positioning signal transceiving areas achieve at least two transmission and reception response processes through different transmission paths, that is, they all pass through different positioning signal transceiving areas on the positioning system through the transmission paths. T₁ or T₂ is the transmission feature quantity of the two paths between two positioning modules.

When i₁≠j₁ and i₂≠j₂, one of the positioning signal transceiving areas i₂, j₂ may be the same positioning signal transceiving area as one of the positioning signal transceiving areas i₁, j₁. The positioning module 1 or the positioning module 2 and the positioning mobile terminal achieve at least two transmission and reception response processes through different transmission paths, that is, they all pass through different positioning signal transceiving areas on the positioning system through the transmission paths. T₁ or T₂ is the total transmission time of the two paths between two positioning modules.

It can be seen that this system of equations is a scenario where k is set to 2 in the above-mentioned embodiments. The present system of equations can be a system of equations obtained by each of two positioning modules performing signal transmission and reception once, and in the case where the number of the equations is insufficient, the preset reference coordinate can be read to replace x, y or z in the system of equations, and the signal transmission and reception can also be performed again, so as to obtain more equations to solve the system of equations. The parameters of this system of equations are similar to those in the above-mentioned embodiments, and will not be repeated herein.

In the embodiments of the present application, the function of the connection module is similar to that of the above-mentioned positioning base station, and the function of the second data transceiving module is similar to that of the data transceiving module in the above-mentioned embodiments, and thus the technical effects obtained are also similar, and will not be repeated herein.

FIG. 7 is a sixth schematic structural diagram of a positioning system according to an embodiment of the present application. As shown in FIG. 7, in a possible implementation, the parsing module is further configured to receive the auxiliary transmission feature quantity sent by the connection module, and determine a second spatial coordinate according to each transmission feature quantity and each auxiliary transmission feature quantity.

Specifically, the auxiliary transmission feature quantity may be transmitted by the data transceiving module, and or may be transmitted by the communication base station in a case where the connection module includes a communication base station. The determining the second spatial coordinate according to each transmission feature quantity and each auxiliary transmission feature quantity may be performed by determining the total number of auxiliary transmission feature quantity and the transmission feature quantity as a target number, where in the case where the target number is greater than or equal to 3, not reading the reference coordinate, and while in the case where the target number is less than 3, reading the reference coordinate and searching for a corresponding relationship between the auxiliary transmission feature quantity and the positioning signal transceiving area as well as a corresponding relationship between the transmission feature quantity and the positioning signal transceiving area, so as to obtain the target positioning signal transceiving area; searching for a preset corresponding relationship between the positioning signal transceiving area and structural information, so as to obtain each piece of target structural information corresponding to each target positioning signal transceiving area, and determining the first spatial coordinate of the terminal device according to the preset reference coordinate, each piece of target structural information and each transmission feature quantity. The specific details of the embodiment of the present application are similar to those of the above embodiments, and will not be repeated herein.

As can be seen from the description of the above-mentioned embodiment, in the embodiments of the present application, the positioning module receives the auxiliary transmission feature quantity sent by the connection module, so as to obtain the spatial coordinate of the terminal device by combining the auxiliary transmission feature quantity and the transmission feature quantity, thereby achieving the effects of increasing data collection routes and solving the coordinate of the terminal device.

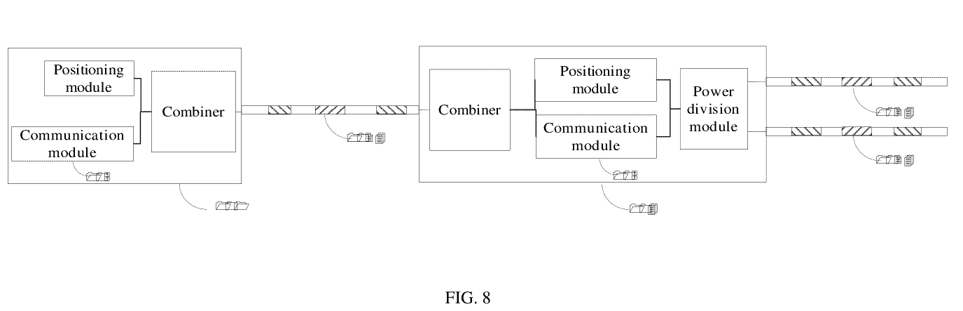

FIG. 8 is a seventh schematic structural diagram of a positioning system according to an embodiment of the present application. In a possible implementation, the positioning base station 101 and/or the connection module 104 further includes a communication module 105.

The communication module may be a communication base station, and when only the positioning base station contains the communication module, both the positioning module and the communication module are high-power devices. The communication module and positioning module in the positioning base station and the connection module can be connected in parallel through a combiner, and then are split through a power division or coupling module, so as to respectively input the communication signal and the positioning signal to a plurality of data transceiving modules, and at this time, both the positioning module and the communication module are low-power devices. The above-mentioned load module may also include a communication module, which is also combined with the positioning module through a combiner, and is input into the data transceiving module after being split by a power division or coupling module.

Correspondingly, the data transceiving module further includes a communication signal transceiving area 1024.

The communication signal transceiving area may be a slot or antenna that is different from the positioning signal transceiving area.

The communication module is configured to input a communication signal into the data transceiving module, so that the communication signal is sent from the communication signal transceiving area to an air.

In a possible implementation, the communication module included in the connection module can be replaced by a communication amplification module, and the communication amplification module and the positioning module are connected through a combiner, so as to input the communication signal and the positioning signal into the data transceiving module.

In a possible implementation, when the positioning base station includes the positioning module and the communication module, the positioning module may transmit a communication frequency band, or the non-positioning module becomes a communication signal transceiving area, and a strength of the positioning signal of the positioning signal transceiving area is at least 2 decibels greater than a strength of the positioning signal leaked from the communication signal transceiving area. When the positioning base station includes the positioning module and the communication module, the positioning information of the positioning module can be transmitted to the communication module through the data transceiving module, and is sent back to the server through the communication module.

As can be seen from the description of the above-mentioned embodiment, in the embodiments of the present application, by adding the communication module and the communication signal transceiving area of the data transceiving module, the transmission of the communication signal can be achieved. Since the positioning signal and the communication signal are achieved through a unified system, the effect of reducing costs can be achieved.

In a possible implementation, the system further includes: at least one load module, and the load module includes a secondary auxiliary positioning module.

Specifically, if the positioning base station is one end of the positioning system, the load module may be served as the other end of the positioning system. The secondary auxiliary positioning module is similar to the above-mentioned positioning module and auxiliary positioning module, and is named to distinguish the positioning base station, the connection module and the load module.

One end of the data transceiving module is connected to the positioning module, and the other end of the data transceiving module is connected to the secondary auxiliary positioning module.

The load module is configured to perform information interaction with the terminal device through the positioning signal transceiving area of the data transceiving module, so as to generate a secondary auxiliary sending feature and a secondary auxiliary receiving feature of each piece of information, where the secondary auxiliary sending feature includes a secondary auxiliary sending time or a secondary auxiliary sending phase, and the secondary auxiliary receiving feature includes a secondary auxiliary receiving time or a secondary auxiliary receiving phase.

Specifically, the interaction process of the embodiments of the present application is similar to that of the positioning module and the terminal device, and will not repeated herein.

The parsing module is configured to receive the secondary auxiliary sending feature and the secondary auxiliary receiving feature of each piece of information sent by the secondary auxiliary positioning module and/or the terminal device as well as a corresponding secondary auxiliary positioning module identifier and a corresponding terminal device identifier; determine at least one secondary auxiliary transmission feature quantity according to the secondary auxiliary sending feature and the secondary auxiliary receiving feature of each piece of information as well as the corresponding secondary auxiliary positioning module identifier and the corresponding terminal device identifier, where the secondary auxiliary transmission feature quantity includes a secondary auxiliary total transmission time or a secondary auxiliary total transmission phase difference, and corresponds to the secondary auxiliary positioning module identifier and the terminal device identifier; and determine a third spatial coordinate of the terminal device according to each secondary auxiliary transmission feature quantity and each secondary auxiliary positioning module identifier.

Specifically, the embodiments of the present application are similar to the process of solving the first spatial coordinate by the parsing module in the above-mentioned embodiment, and will not be repeated herein.

As can be seen from the description of the above-mentioned embodiment, in the embodiments of the present application, by using the load module to perform information transmission and reception with the terminal device, the corresponding secondary auxiliary sending feature and secondary auxiliary receiving feature are obtained, and the spatial coordinate of the terminal device is solved through the secondary auxiliary sending feature, the secondary auxiliary receiving feature as well as the corresponding positioning module identifier, so that the terminal device can be positioned through a system terminal end, thereby increasing the positioning accuracy.

In a possible implementation, the load module further includes an antenna module.

The antenna module may be any one of a medium gain antenna, a high gain antenna, a dual-polarized antenna, a single-polarized antenna, and an omni-directional antenna.

The antenna module is connected to the secondary auxiliary positioning module.

The connection method may be electrical connection or communication connection.

The load module is further configured to perform information interaction with the terminal device through the antenna module.

The interaction method between the load module and the terminal device may be performing information transmission and information reception, where the information may be one or more of the positioning signal, the feedback signal, and the positioning request.

In a possible implementation, the parsing module is further configured to:
determine an identifier of a corresponding target positioning signal transceiving area according to each transmission feature quantity and each corresponding positioning module identifier.

Specifically, the determination method may be searching for a corresponding relationship between a corresponding transmission feature quantity interval and the identifier of positioning signal transceiving area according to each positioning module identifier, and obtaining the identifier of the corresponding target positioning signal transceiving area according to the transmission feature quantity interval to which each transmission feature quantity belongs and the above-mentioned corresponding relationship.

A priority of each transmission feature quantity is determined according to the identifier of the target positioning signal transceiving area corresponding to each transmission feature quantity and the corresponding positioning module identifier.

Specifically, the priority may be determined by searching for a preset corresponding relationship between the identifier and an attribute according to the identifier of the target positioning signal transceiving area corresponding to the transmission feature quantity, so as to obtain the attribute of the corresponding target positioning signal transceiving area; determining a target data transceiving module to which the positioning signal transceiving area belongs, a target positioning base station to which the target positioning module belongs, a positional relationship between the target data transceiving module and the target positioning base station; and determining the priority of each transmission feature quantity according to the attribute of the target positioning signal transceiving area, a target data transceiving module to which the target positioning signal transceiving area belongs, and the positional relationship.

The attribute may include the signal transceiving area being an antenna, and the signal transceiving area being an embedded hole.

The details may be as follows.

If an attribute of a target positioning signal transceiving area corresponding to a transmission feature quantity is an antenna, then a first priority is determined as a priority of this transmission feature quantity.

If target data transceiving modules corresponding to at least two transmission feature quantities are data transceiving modules connected to both sides of the same target positioning base station, then a second priority is determined as a priority of these two transmission feature quantities.

If target data transceiving modules corresponding to at least two transmission feature quantities are data transceiving modules connected to one side of the same target positioning base station, then a third priority is determined as a priority of these two transmission feature quantities.

If target data transceiving modules corresponding to at least two transmission feature quantities are data transceiving modules between two target positioning modules, then a fourth priority is determined as a priority of these two transmission feature quantities.

If target data transceiving modules corresponding to at least two transmission feature quantities are the same data transceiving module and the corresponding target positioning modules are the same positioning module, then a fifth priority is determined as a priority of these two transmission feature quantities.

The transmission feature quantity is ranked in a descending order of priorities, so as to obtain a transmission feature quantity sequence.

Specifically, for example, there are five transmission feature quantities at present, which respectively correspond to five priorities, and the transmission feature quantity with the highest priority is ranked first, and then ranking is sequentially performed until the transmission feature quantity with the lowest priority.

A spatial coordinate of the terminal device is determined by using the first N transmission feature quantity in the transmission feature quantity sequence, where N is a positive integer.

Specifically, N may be, for example, 3, 4, or 5. When the number of the transmission feature quantity is less than or equal to 3, all transmission feature quantities may also be sent to the parsing module.

As can be seen from the description of the above embodiments, in the embodiments of the present application, the identifier of the corresponding target positioning signal transceiving area is determined according to each transmission feature quantity and each corresponding positioning module identifier, the priority of each transmission feature quantity is determined according to the identifier of the target positioning signal transceiving area corresponding to each transmission feature quantity and the corresponding positioning module identifier, each transmission feature quantity is ranked from high to low according to the priority to obtain the transmission feature quantity sequence, and the spatial coordinate of the terminal device is determined by using the first N transmission feature quantity in the transmission feature quantity sequence, so that a more reliable transmission feature quantity can be processed preferentially, thereby achieving the effect of obtaining a more accurate spatial coordinate.

Specifically, the determination method of priority may be determining the attribute of the corresponding target positioning signal transceiving area according to the identifier of the target positioning signal transceiving area corresponding to the transmission feature quantity, where the attribute of the target positioning signal transceiving area includes whether it belongs to the first data transceiving module, whether it belongs to the second data transceiving module, and whether it belongs to the positioning signal transceiving area at two ends of any one data transceiving module and the identifier of the second data transceiving module to which it belongs. The target positioning signal transceiving area is an antenna or the target positioning signal transceiving area is an embedded hole. The target positioning module is determined to be connected to the first data transceiving module or the target positioning module is determined to be connected to the second data transceiving module according to the identifier of the target positioning module. The priority of the transmission feature quantities is determined according to the attribute of the target positioning signal transceiving area and the data transceiving module connected to the target positioning module.

Specifically, the method for determining the priority may specifically be as follows:
determining any transmission feature quantity as a transmission feature quantity to be positioned;
if a target positioning signal transceiving area corresponding to the transmission feature quantity to be positioned belongs to a second data transceiving module, the target positioning module is a secondary auxiliary positioning module connected to the second data transceiving module, and the target positioning signal transceiving area is an antenna, then determining a first level as the priority of the transmission feature quantity to be positioned;
if the target positioning signal transceiving area corresponding to the transmission feature quantity to be positioned belongs to the second data transceiving module, the target positioning module is an auxiliary positioning module connected to the second data transceiving module, and the target positioning signal transceiving area is an antenna, then determining a second level as the priority of the transmission feature quantity to be positioned;
if the target positioning signal transceiving area corresponding to the transmission feature quantity to be positioned belongs to the second data transceiving module, the target positioning module is the auxiliary positioning module connected to the second data transceiving module, and the target positioning signal transceiving area belongs to positioning signal transceiving areas at two ends of the second data transceiving module, then determining a third level as the priority of the transmission feature quantity to be positioned;
if the target positioning signal transceiving area corresponding to the transmission feature quantity to be positioned belongs to the second data transceiving module, and the transmission feature quantity to be positioned is a minimum value of each transmission feature quantity, then determining a fourth level as the priority of the transmission feature quantity to be positioned;
if the target positioning signal transceiving area corresponding to the transmission feature quantity to be positioned belongs to a first data transceiving module, the target positioning module is a positioning module connected to the first data transceiving module, and the target positioning signal transceiving area is an antenna, then determining a fifth level as the priority of the transmission feature quantity to be positioned;
if the target positioning signal transceiving area corresponding to the transmission feature quantity to be positioned belongs to the first data transceiving module, the target positioning module is the positioning module connected to the first data transceiving module, and the target positioning signal transceiving area belongs to the positioning signal transceiving areas at two ends of the first data transceiving module, then determining a sixth level as the priority of the transmission feature quantity to be positioned; and
if the target positioning signal transceiving area corresponding to the transmission feature quantity to be positioned belongs to the first data transceiving module, determining a first data transceiving module adjacent to the data transceiving module corresponding to the transmission feature quantity to be positioned in the first data transceiving module corresponding to each transmission feature quantity according to an identifier the first data transceiving module corresponding to each transmission feature quantity, and if there is a first data transceiving module corresponding to the transmission feature quantity belonging to the adjacent first data transceiving module, then determining a seventh level as the priority of the transmission feature quantity to be positioned.

The transmission feature quantity to be positioned already having the corresponding priority is determined as a positioned transmission feature quantity.

Each positioned transmission feature quantity is ranked in the order of first level, second level, third level, fourth level, fifth level, sixth level, and seventh level to obtain the transmission feature quantity sequence.

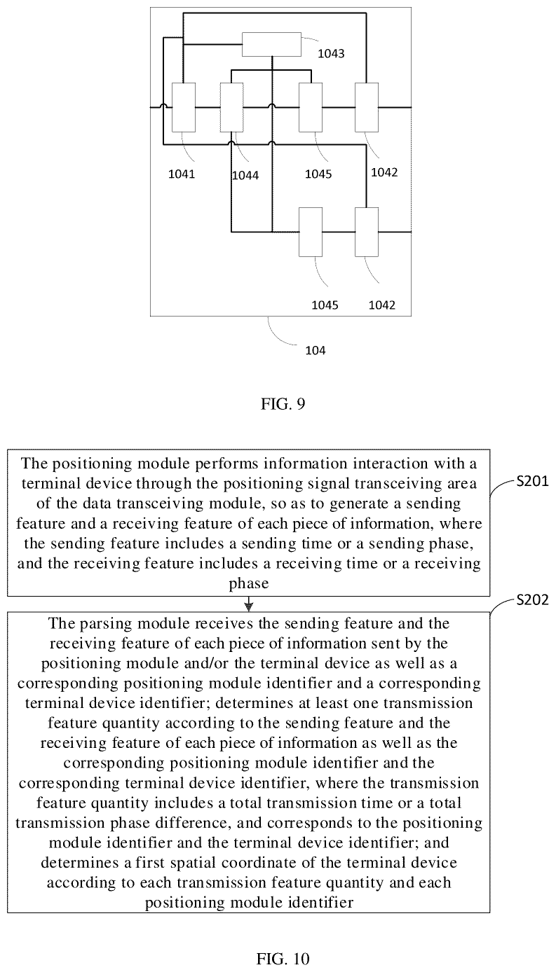

FIG. 9 is a schematic structural diagram of a connection module according to an embodiment of the present application. As shown in FIG. 9, the connection module 104 includes:
a first power coupling divider 1041, at least one second power coupling divider 1042, at least one auxiliary positioning module 1043, a power distribution unit 1044 and at least one combiner 1045.

A first end of the first power coupling divider 1041 serves as a first end of the connection module. A second end of the first power coupling divider 1041 is connected to a first input end of the power distribution unit 1044, a third end of the first power coupling divider 1041 is connected to a first end of the auxiliary positioning module 1043, and the third end is connected to a first input end of the second power coupling divider 1042. A first output end of the power distribution unit 1044 is connected to a second end of the auxiliary positioning module 1043, and a second output end of the power distribution unit 1044 is connected to a first input end of the combiner 1045. The second end of the auxiliary positioning module 1043 is connected to a second input end of the combiner 1045, an output end of the combiner 1045 is connected to a second input end of the second power coupling divider 1042, and an output end of the second power coupling divider 1042 serves as a second end of the connection module.

The first power coupling divider 1041 is configured to obtain a positioning signal from the positioning module on the positioning base station side and obtain an external current, input the current to the auxiliary positioning module 1043 and the second power coupling divider 1042, and input the positioning signal and the communication signal to the power distribution unit 1044. The auxiliary positioning module 1043 is configured to input the positioning signal into the power distribution unit 1044, and the auxiliary positioning module 1043 is configured to input the positioning signal into the second data transceiving module through the combiner 1045 and the second coupling divider 1042.

The power distribution unit may be a power divider or a coupler, or a combination of a power divider and a coupler, and the power coupling divider may be a combination of one or more of a current coupler and a power divider, and may also be a power coupling divider.

As can be seen from the description of the embodiments of the present application, in the embodiments of the present application, the components in other connection modules may be supplied power through the power coupling divider, and the power distribution unit can input a positioning signal of a first source module side to the first positioning base station, and can also input the positioning signal output by the first positioning base station into the data transceiving module, so as to achieve the continuous transmission of the positioning signal and the supplementation of the positioning signal.

In a possible implementation, in a case where the connection module in the above embodiment does not include a positioning module, the connection module may include one or more combinations of a jumper module, a power divider module and a coupling module, and at this time, the positioning base station and the communication base station are both high-power devices. In a case where the connection module includes the positioning module and the communication base station/communication amplifier, both the positioning base station and the communication base station are low-power devices. The dividing boundary between the high-power and the low-power may be 20 W, a power greater than or equal to 20 W is high-power, and a power less than 20 W is low-power. The above formula is only an embodiment, and any simplification or improvement of the formula falls within the protection scope of the present application. The above three positioning solutions can be further combined and solved, so as to obtain a more precise positioning coordinate and more dimensional positioning coordinate information.

FIG. 10 is a schematic flow diagram of a positioning method according to an embodiment of the present application, which is applied to a positioning system. The positioning system includes a positioning base station, n data transceiving module and a parsing module, where the positioning base station includes a positioning module, and each data transceiving module includes at least one positioning signal transceiving area, where n is a positive integer; and the positioning module is connected to one end of the data transceiving module. As shown in FIG. 10, the method includes the following steps.

S201: the positioning module performs information interaction with a terminal device through the positioning signal transceiving area of the data transceiving module, so as to generate a sending feature and a receiving feature of each piece of information, where the sending feature includes a sending time or a sending phase, and the receiving feature includes a receiving time or a receiving phase.

S202: the parsing module receives the sending feature and the receiving feature of each piece of information sent by the positioning module and/or the terminal device as well as a corresponding positioning module identifier and a corresponding terminal device identifier; determines at least one transmission feature quantity according to the sending feature and the receiving feature of each piece of information as well as the corresponding positioning module identifier and the corresponding terminal device identifier, where the transmission feature quantity includes a total transmission time or a total transmission phase difference, and corresponds to the positioning module identifier and the terminal device identifier; and determines a first spatial coordinate of the terminal device according to each transmission feature quantity and each positioning module identifier.

The method provided in this embodiment may be used to implement the technical solutions of the above-mentioned system embodiments, and the implementation principles and technical effects thereof are similar, and will not be repeated herein in this embodiment.

In a possible implementation, in the step S202, the determining the first spatial coordinate of the terminal device according to each transmission feature quantity and each positioning module identifier specifically includes:

S2021: obtaining the number of the transmission feature quantity, and determining the first spatial coordinate of the terminal device according to the number of the transmission feature quantity, each positioning module identifier and each transmission feature quantity.

The method provided in this embodiment may be used to implement the technical solutions of the above-mentioned system embodiments, and the implementation principles and technical effects thereof are similar, and will not be repeated herein in this embodiment.

In a possible implementation, the step S2021 specifically includes:

S20211: if the number of the transmission feature quantity is greater than or equal to 3, determining a target position of each target positioning module according to the positioning module identifier, where the target positioning module is a positioning module that performs signal transmission and reception; determining an identifier of each corresponding target positioning signal transceiving area according to each transmission feature quantity and the corresponding positioning module identifier, where the target positioning signal transceiving area includes a positioning signal transceiving area through which each piece of information passes; searching for each piece of target structural information corresponding to the identifier of each target positioning signal transceiving area; and determining the first spatial coordinate of the terminal device according to each piece of target structural information, the target position of each target positioning module and each transmission feature quantity.

The method provided in this embodiment may be used to implement the technical solutions of the above-mentioned system embodiments, and the implementation principles and technical effects thereof are similar, and will not be repeated herein in this embodiment.

In a possible implementation, the target structural information includes a target angle of the target positioning signal transceiving area and a target distance from the positioning base station to the target positioning signal transceiving area, where the target positioning module is a positioning module that performs information interaction. In the above-mentioned step S20211, the determining the first spatial coordinate of the terminal device according to each piece of target structural information, the target position of each target positioning module and each transmission feature quantity specifically includes: searching for a preset corresponding relationship between the transmission feature quantity, the positioning module identifier and an error according to each transmission feature quantity and the positioning module identifier, so as to obtain each target error; and inputting each target position, each target angle, each target distance, each target error and each transmission feature quantity into a preset formula, so as to obtain the first spatial coordinate of the terminal device The method provided in this embodiment may be used to implement the technical solutions of the above-mentioned system embodiments, and the implementation principles and technical effects thereof are similar, and will not be repeated herein in this embodiment.

In a possible implementation, the step S2021 specifically includes:

S20212: if the number of the transmission feature quantity is 1 or 2, obtaining a preset reference coordinate; obtaining a target position of each target positioning module according to the positioning module identifier, where the target positioning module is a positioning module that performs signal transmission and reception; determining an identifier of each corresponding target positioning signal transceiving area according to each transmission feature quantity and the corresponding positioning module identifier, where the target positioning signal transceiving area is a positioning signal transceiving area through which each piece of information passes; searching for each piece of target structural information corresponding to the identifier of each target positioning signal transceiving area; and determining the first spatial coordinate of the terminal device according to the preset reference coordinate, each piece of target structural information, the target position of each target positioning module and each transmission feature quantity.

The method provided in this embodiment may be used to implement the technical solutions of the above-mentioned system embodiments, and the implementation principles and technical effects thereof are similar, and will not be repeated herein in this embodiment.

In a possible implementation, in the above-mentioned step S202, the determining the at least one transmission feature quantity according to the sending feature and the receiving feature of each piece of information as well as the corresponding positioning module identifier and the corresponding terminal device identifier specifically includes: inputting a positioning signal to the data transceiving module, and recording a sending time of the positioning signal; sending, by the data transceiving module, the positioning signal from the positioning signal transceiving area to an air, and receiving a feedback signal sent by the terminal device according to the positioning signal to generate a receiving time, where the feedback signal includes the terminal device identifier; receiving, by the positioning module, each feedback signal sent by the data transceiving module and recording each receiving time corresponding to each feedback signal, and sending each sending time, each receiving time, the corresponding positioning module identifier and the corresponding terminal device identifier to the parsing module; and determining, by the parsing module, each corresponding total transmission time according each sending time, each receiving time, the corresponding positioning module identifier and the corresponding terminal device identifier; or receiving a positioning request transmitted by the terminal device through the positioning signal transceiving area, where the positioning request includes a sending time of the positioning request and a corresponding terminal device identifier; receiving, by the positioning module, each positioning request sent by the data transceiving module and recording a receiving time of each positioning request, and sending the sending time of each positioning request, the receiving time of each positioning request, the corresponding positioning module identifier and the corresponding terminal device identifier to the parsing module; and determining, by the parsing module, each corresponding total transmission time according to the sending time of each positioning request, the receiving time of each positioning request, the corresponding positioning module identifier and the corresponding terminal device identifier; or receiving a positioning request transmitted by the terminal device through the positioning signal transceiving area, where the positioning request includes a sending time of the positioning request and a corresponding terminal device identifier; receiving, by the positioning module, each positioning request sent by the data transceiving module and recording a receiving time of each positioning request, and inputting a positioning signal to the data transceiving module and recording a sending time of each positioning signal; sending, by the data transceiving module, the positioning signal from the positioning signal transceiving area to an air; receiving a feedback signal sent by the terminal device according to the positioning signal, and sending the feedback signal to the positioning module, where the feedback signal includes a sending time of the feedback signal and a corresponding terminal device identifier; receiving, by the positioning base station, each feedback signal sent by the data transceiving module and recording a receiving time of each feedback signal, and sending the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier to the parsing module; and determining, the parsing module, each total transmission time according to the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioning module identifier.

The method provided in this embodiment may be used to implement the technical solutions of the above-mentioned system embodiments, and the implementation principles and technical effects thereof are similar, and will not be repeated herein in this embodiment.

In a possible implementation, the data transceiving module includes a first data transceiving module and a second data transceiving module; and the system further includes: at least one connection module; where one end of the first data transceiving module is connected to the positioning module, and the other end of the first data transceiving module is connected to one end of the connection module; the second data transceiving module is connected to the connection module; and the positioning method further includes: the connection module receives a positioning signal input by the positioning base station through the first data transceiving module and input the positioning signal into the second data transceiving module, so that the positioning signal is sent to an air through the second data transceiving module; and receives a feedback signal input by the terminal device through the second data transceiving module and sends the feedback signal to the positioning base station through the first data transceiving module.

The method provided in this embodiment may be used to implement the technical solutions of the above-mentioned system embodiments, and the implementation principles and technical effects thereof are similar, and will not be repeated herein in this embodiment.

In a possible implementation, the data transceiving module includes a first data transceiving module and a second data transceiving module; the system further includes: at least one connection module; and the connection module includes an auxiliary positioning module; where one end of the first data transceiving module is connected to the positioning module, and the other end of the first data transceiving module is connected to the auxiliary positioning module; the second data transceiving module is connected to the auxiliary positioning module; and the positioning method further includes: the connection module performs information interaction with the terminal device through a positioning signal transceiving area of the first data transceiving module and/or the second data transceiving module, so as to generate an auxiliary sending feature and an auxiliary receiving feature of each piece of information, where the auxiliary sending feature includes an auxiliary sending time or an auxiliary sending phase, and the auxiliary receiving feature includes an auxiliary receiving time or an auxiliary receiving phase; receiving, by the parsing module, the auxiliary sending feature and the auxiliary receiving feature of each piece of information sent by the auxiliary positioning module and/or the terminal device as well as a corresponding auxiliary positioning module identifier and the corresponding terminal device identifier; determining at least one auxiliary transmission feature quantity according to each auxiliary sending feature and each auxiliary receiving feature as well as the corresponding auxiliary positioning module identifier and the corresponding terminal device identifier, where the auxiliary transmission feature quantity includes an auxiliary total transmission time or an auxiliary total transmission phase difference, and corresponds to the auxiliary positioning module identifier and the terminal device identifier; and determining a second spatial coordinate of the terminal device according to each auxiliary transmission feature quantity and each auxiliary positioning module identifier.

The method provided in this embodiment may be used to implement the technical solutions of the above-mentioned system embodiments, and the implementation principles and technical effects thereof are similar, and will not be repeated herein in this embodiment.

In a possible implementation, the positioning base station and/or the connection module further includes a communication module; correspondingly, the data transceiving module further includes a communication signal transceiving area; and the positioning method further includes: inputting, by the communication module, a communication signal into the data transceiving module, so that the communication signal is sent from the communication signal transceiving area to an air.

The method provided in this embodiment may be used to implement the technical solutions of the above-mentioned system embodiments, and the implementation principles and technical effects thereof are similar, and will not be repeated herein in this embodiment.

In a possible implementation, the positioning system further includes: at least one load module, where the load module includes a secondary auxiliary positioning module; one end of the data transceiving module is connected to the positioning module, and the other end of the data transceiving module is connected to the secondary auxiliary positioning module; and
the positioning method further includes:
performing, by the load module, information interaction with the terminal device through the positioning signal transceiving area of the data transceiving module, so as to generate a secondary auxiliary sending feature and a secondary auxiliary receiving feature of each piece of information, where the secondary auxiliary sending feature includes a secondary auxiliary sending time or a secondary auxiliary sending phase, and the secondary auxiliary receiving feature includes a secondary auxiliary receiving time or a secondary auxiliary receiving phase; receiving, by the parsing module, the secondary auxiliary sending feature and the secondary auxiliary receiving feature of each piece of information sent by the secondary auxiliary positioning module and/or the terminal device as well as a corresponding secondary auxiliary positioning module identifier and the corresponding terminal device identifier; determining at least one secondary auxiliary transmission feature quantity according to the secondary auxiliary sending feature and the secondary auxiliary receiving feature of each piece of information as well as the corresponding secondary auxiliary positioning module identifier and the corresponding terminal device identifier, where the secondary auxiliary transmission feature quantity includes a secondary auxiliary total transmission time or a secondary auxiliary total transmission phase difference, and corresponds to the secondary auxiliary positioning module identifier and the terminal device identifier; and determining a third spatial coordinate of the terminal device according to each secondary auxiliary transmission feature quantity and each secondary auxiliary positioning module identifier.

The method provided in this embodiment may be used to implement the technical solutions of the above-mentioned system embodiments, and the implementation principles and technical effects thereof are similar, and will not be repeated herein in this embodiment.

In a possible implementation, the load module further includes: an antenna module, the antenna module is connected to the secondary auxiliary positioning module; and the positioning method further includes: performing, by the load module, information interaction with the terminal device through the antenna module. The above-mentioned primary data transceiving module may be the same as the above-mentioned first data transceiving module, and the above-mentioned auxiliary transceiving module may be the same as the above-mentioned second data transceiving module.

In a possible implementation method, in the above-mentioned step S202, the determining the first spatial coordinate of the terminal device according to each transmission feature quantity and each positioning module identifier specifically includes: determining an identifier of a corresponding target positioning signal transceiving area according to each transmission feature quantity and each corresponding positioning module identifier; determining a priority of each transmission feature quantity according to the identifier of the target positioning signal transceiving area corresponding to each transmission feature quantity and the corresponding positioning module identifier; ranking the transmission feature quantity in a descending order of priorities, so as to obtain a transmission feature quantity sequence; and determining a spatial coordinate of the terminal device by using the first N transmission feature quantity in the transmission feature quantity sequence, where N is a positive integer. The method provided in this embodiment may be used to implement the technical solutions of the above-mentioned system embodiments, and the implementation principles and technical effects thereof are similar, and will not be repeated herein in this embodiment.

In order to implement the above-mentioned embodiments, an embodiment of the present application further provides an electronic device.

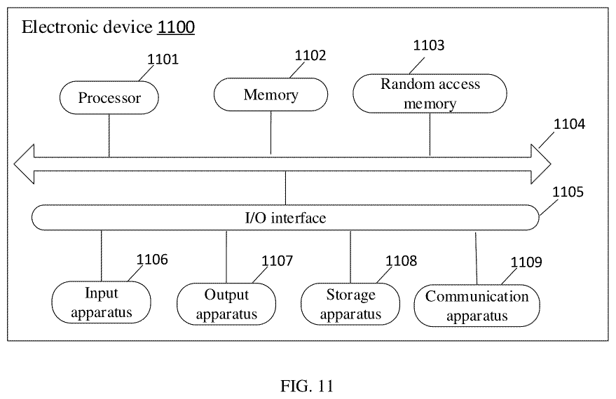

Referring to FIG. 11, a schematic structural diagram of an electronic device 1100 suitable for implementing the embodiments of the present application is shown, and the electronic device 1100 may be a terminal device or a server. The terminal device may include, but is not limited to, a mobile terminal such as a mobile phone, a laptop computer, a digital broadcast receiver, a personal digital assistant (Personal Digital Assistant, PDA for short), a portable android device (Portable Android Device, PAD for short), a portable multimedia player (Portable Media Player, PMP for short), a vehicle-mounted terminal (for example, a vehicle-mounted navigation terminal), etc., and a fixed terminal such as a digital TV, a desktop computer, etc. The electronic device shown in FIG. 11 is only an example, and should not bring any limitations to the functions and scope of use of the embodiments of the present application.

As shown in FIG. 11, the electronic device 1100 may include a processor 1101 (e.g., a central processing unit, a graphics processor, etc.), and a memory 1102 connected in communication with the processor, which can perform various appropriate actions and processes according to programs stored in the memory 1102, computer-executable instructions, or programs loaded from the storage apparatus 1108 into a random access memory (Random Access Memory, RAM for short) 1103, so as to implement the positioning method in any one of the above embodiments, where the memory may be a read only memory (Read Only Memory, ROM for short). Various programs and data required for the operation of the electronic device 1100 are also stored in the RAM 1103. The processor 1101, the memory 1102, and the RAM 1103 are connected to each other through the bus 1104. An input/output (I/O) interface 1105 is also connected to the bus 1104.

In general, the following apparatuses may be connected to the I/O interface 1105, including: an input apparatus 1106 such as a touchscreen, a touchpad, a keyboard, a mouse, a camera, a microphone, an accelerometer, a gyroscope, etc.; an output apparatus 1107 such as a liquid crystal display (Liquid Crystal Display, LCD for short), a speaker, a vibrator, etc.; a storage apparatus 1108 such as a magnetic tape, a hard disk, etc.; and a communication apparatus 1109. The Communication apparatus 1109 may allow the electronic device 1100 to wirelessly or wired communicate with other devices to exchange data. Although FIG. 11 illustrates an electronic device 1100 with various apparatuses, it should be understood that not all of the apparatuses illustrated are required to be implemented or provided. It can be alternatively implemented or provided with more or fewer apparatuses.

In particular, according to the embodiments of the present application, the processes described above with reference to the flowcharts can be implemented as a computer software program. For example, the embodiments of the present application include a computer program product including a computer program carried on a computer-readable storage medium, and the computer program includes a program code for implementing the method as shown in the flowchart. In such embodiments, the computer program may be downloaded and installed from the network through the Communication apparatus 1109, or installed from the storage apparatus 1108, or installed from the memory 1102. When the computer program is implemented by the processor 1101, the above-mentioned functions defined in the method according to the embodiments of the present application are implemented.

It should be noted that the computer-readable storage medium in the present application may be a computer-readable signal medium or a computer storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a random access memory (RAM), a read only memory (ROM), an erasable programmable read only memory (EPROM or Flash memory), an optical fiber, a portable compact disc read only memory (CD-ROM), an optical storage apparatus, a magnetic storage apparatus, or any suitable combination thereof. In the present application, the computer-readable storage medium may be any tangible medium that may contain or store a program for use by or in connection with an instruction execution system, apparatus, or device. However, in the present application, a computer-readable signal medium may include a propagated data signal in a baseband or as part of a carrier wave, and the computer-readable program code is carried therein. This propagated data signal can take various forms, including, but not limited to, an electro-magnetic, an optical signal, or any suitable combination thereof. The computer-readable signal medium may also be any computer-readable signal medium other than the computer-readable storage medium, which can send, propagate, or transmit a program for use by or in connection with the instruction execution system, apparatus, or device. The program code contained on the computer-readable storage medium may be transmitted using any appropriate medium, including, but not limited to, wires, optical cables, RF (radio frequency), etc., or any suitable combination thereof.

The computer-readable storage medium may be included in the electronic device, or may exist independently without being assembled into the electronic device.

The above-mentioned computer-readable storage medium carries one or more programs which, when implemented by the electronic device, enable the electronic device to perform the method shown in the above-mentioned embodiments.

The computer program code for performing operations of the present application may be written in any combination of one or more programming languages, including an object oriented programming language such as Java, Smalltalk, C++, etc., and conventional procedural programming languages, such as a “C” programming language or similar programming languages. The program code may be implemented entirely on the user's computer, partially on the user's computer, as a standalone software package, partially on the user's computer and partially on a remote computer, or entirely on the remote computer or server. In the case involving the remote computer, the remote computer may be connected to the user's computer through any type of network, including a local area network (LAN) or a wide area network (WAN), or may be connected to an external computer (such as using an internet service provider to connect through the internet).

The flowchart and block diagrams in the accompanying drawings illustrate the possible implementation architecture, functionality, and operation of the system, the method and the computer program products according to various embodiments of the present application. In this regard, each block in the flowchart or block diagrams may represent a module, program segment, or part of code, which includes one or more executable instructions for implementing specified logical functions. It should also be noted that, in some alternative implementations, the functions noted in the blocks may occur out of the order noted in the drawings. For example, two consecutive blocks may actually be implemented in parallel, or they may sometimes be implemented in a reverse order, depending upon the functions involved. It should also be noted that each block of the block diagrams and/or flowchart as well as combinations of the blocks in the block diagrams and/or flowchart illustration, can be implemented by special purpose hardware-based systems that perform specified functions or acts, or by combinations of special purpose hardware and computer instructions.

The functions described herein above may be performed, at least in part, by one or more hardware logic components. For example, without limitation, exemplary types of the hardware logic components that can be used include: a field-programmable gate array (FPGA), an application specific integrated circuit (ASIC), an application specific standard product (ASSP), a system-on-a-chip system (SOC), a complex programmable logic devices (CPLD), etc.

The present application further provides a computer-readable storage medium, where the computer-readable storage medium stores computer execution instructions, when the processor implements the computer execution instructions, the technical solutions of the positioning method in any one of the above-mentioned embodiments is achieved, where the implementation principle and technical effects thereof are similar to those of the positioning method, which can be referred to as the implementation principle and beneficial effects of the positioning method, and will not be repeated herein.

In the context of this application, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer diskette, a hard disk, a random access memory (RAM), a read only memory (ROM), an erasable programmable read only memory (EPROM or Flash memory), an optical fiber, a portable compact disc read only memory (CD-ROM), an optical storage apparatus, a magnetic storage apparatus, or any suitable combination thereof.

The present application also provides a computer program product, including a computer program. The computer program, when implemented by the processor, implements the technical solution of the positioning method in any one of the described embodiments. The implementation principle and beneficial effect thereof are similar to those of the positioning method, which can be referred to as the implementation principle and beneficial effects of the positioning method, and will not be repeated herein.

The above description is only the preferred embodiments of the present application and the description of the applied technical principle, and it should be understood by those skilled in the art, the disclosure range involved in the present application is not limited to the technical solution formed by the specific combination of the described technical features, should also cover other technical solutions formed by any combination of the above-mentioned technical features or equivalent features thereof without departing from the above-mentioned disclosed concept at the same time. For example, a technical solution formed by replacing the above-mentioned features with (but not limited thereto) technical features having similar functions disclosed in the present application.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of the features. In the description of the present application, “a plurality of” means two or more than two, unless otherwise specifically limited. Both the auxiliary positioning module and the secondary auxiliary positioning module can be positioning modules.

Those skilled in the art will easily come up with other embodiments of the present application after considering the description and practicing the present application disclosed herein. The present application is intended to cover any variations, uses, or adaptive changes of the present application, and these variations, uses, or adaptive changes follow the generic principles of the present application and include common general knowledge or customary technical means in the art not disclosed in the present application. The description and embodiments are only considered exemplary, and the true scope and spirit of the present application are indicated by the following claims.

It should be understood that the present application is not limited to the precise structure described above and shown in the accompanying drawings, and various modifications and changes can be made without departing from the scope thereof. The scope of the present application is limited only by the appended claims.

1-13. (canceled)

14. A positioning system, comprising:
a positioning base station, n data transceivers, and a parser, wherein the positioning base station comprises a positioner, and each data transceiver comprises at least one positioning signal transceiving area, wherein n is a positive integer;
the positioner is connected to one end of the data transceiver;
the positioner is configured to perform information interaction with a terminal device through the positioning signal transceiving area of the data transceiver, so as to generate a sending feature and a receiving feature of each piece of information, wherein the sending feature comprises a sending time or a sending phase, and the receiving feature comprises a receiving time or a receiving phase; and
the parser is configured to receive the sending feature and the receiving feature of each piece of information sent by at least one of the positioner and the terminal device as well as a corresponding positioner identifier and a corresponding terminal device identifier; determine at least one transmission feature quantity according to the sending feature and the receiving feature of each piece of information as well as the corresponding positioner identifier and the corresponding terminal device identifier, wherein the transmission feature quantity comprises a total transmission time or a total transmission phase difference, and corresponds to the positioner identifier and the terminal device identifier; and determine a first spatial coordinate of the terminal device according to each transmission feature quantity and each positioner identifier.

15. The system according to claim 14, wherein the parser is configured to obtain a number of the transmission feature quantity, and determine the first spatial coordinate of the terminal device according to the number of the transmission feature quantity, each positioner identifier and each transmission feature quantity.

16. The system according to claim 15, wherein the parser is configured to: in a condition that the number of the transmission feature quantity is greater than or equal to 3, determine a target position of each target positioner according to the positioner identifier, wherein the target positioner is a positioner that performs signal transmission and reception; determine an identifier of each corresponding target positioning signal transceiving area according to each transmission feature quantity and the corresponding positioner identifier, wherein the target positioning signal transceiving area comprises a positioning signal transceiving area through which each piece of information passes; search for each piece of target structural information corresponding to the identifier of each target positioning signal transceiving area; and determine the first spatial coordinate of the terminal device according to each piece of target structural information, the target position of each target positioner and each transmission feature quantity.

17. The system according to claim 16, wherein the target structural information comprises a target angle of the target positioning signal transceiving area and a target distance from the positioning base station to the target positioning signal transceiving area, wherein the target positioner is a positioner that performs information interaction; and the parser is configured to:
search for a preset corresponding relationship between the transmission feature quantity, the positioner identifier and an error according to each transmission feature quantity and the positioner identifier, so as to obtain each target error; and
input each target position, each target angle, each target distance, each target error and each transmission feature quantity into a preset formula, so as to obtain the first spatial coordinate of the terminal device.

18. The system according to claim 15, wherein the parser is configured to: in a condition that the number of the transmission feature quantity is 1 or 2, obtain a preset reference coordinate; determine a target position of each target positioner according to the positioner identifier, wherein the target positioner is a positioner that performs signal transmission and reception; determine an identifier of each corresponding target positioning signal transceiving area according to each transmission feature quantity and the corresponding positioner identifier, wherein the target positioning signal transceiving area is a positioning signal transceiving area through which each piece of information passes; search for each piece of target structural information corresponding to the identifier of each target positioning signal transceiving area; and determine the first spatial coordinate of the terminal device according to the preset reference coordinate, each piece of target structural information, the target position of each target positioner and each transmission feature quantity.

19. The system according to claim 14, wherein the positioner is configured to input a positioning signal to the data transceiver, and record a sending time of the positioning signal; the data transceiver is configured to send the positioning signal from the positioning signal transceiving area to an air; the data transceiver is configured to receive a feedback signal, wherein the feedback signal is sent by the terminal device according to the positioning signal, and the feedback signal comprises the terminal device identifier; the positioner is configured to receive each feedback signal sent by the data transceiver and record each receiving time corresponding to each feedback signal, and send each sending time, each receiving time, the corresponding positioner identifier and the corresponding terminal device identifier to the parser; and the parser is configured to determine each corresponding total transmission time according each sending time, each receiving time, the corresponding positioner identifier and the corresponding terminal device identifier; or
the data transceiver is configured to receive a positioning request transmitted by the terminal device through the positioning signal transceiving area, wherein the positioning request comprises a sending time of the positioning request and a corresponding terminal device identifier; the positioner is configured to receive each positioning request sent by the data transceiver and record a receiving time of each positioning request, and send the sending time of each positioning request, the receiving time of each positioning request, the corresponding positioner identifier and the corresponding terminal device identifier to the parser; and the parser is configured to determine each corresponding total transmission time according to the sending time of each positioning request, the receiving time of each positioning request, the corresponding positioner identifier and the corresponding terminal device identifier; or
the data transceiver is configured to receive a positioning request transmitted by the terminal device through the positioning signal transceiving area, wherein the positioning request comprises a sending time of the positioning request and a corresponding terminal device identifier; the positioner is configured to receive each positioning request sent by the data transceiver and record a receiving time of each positioning request, and input a positioning signal to the data transceiver and record a sending time of each positioning signal; the data transceiver is configured to send the positioning signal from the positioning signal transceiving area to an air; the data transceiver is configured to receive a feedback signal and send the feedback signal to the positioner, wherein the feedback signal is sent by the terminal device according to the positioning signal and comprises a sending time of the feedback signal and a corresponding terminal device identifier; the positioning base station is configured to receive each feedback signal sent by the data transceiver and record a receiving time of each feedback signal, and send the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioner identifier to the parser; and the parser is configured to determine each total transmission time according to the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioner identifier.

20. The system according to claim 14, wherein the data transceiver comprises a first data transceiver and a second data transceiver; and the system further comprises: at least one connector;
wherein one end of the first data transceiver is connected to the positioner, and the other end of the first data transceiver is connected to one end of the connector; the second data transceiver is connected to the connector; and
the connector is configured to receive a positioning signal input by the positioning base station through the first data transceiver and input the positioning signal into the second data transceiver, so that the positioning signal is sent to an air through the second data transceiver; and receive a feedback signal input by the terminal device through the second data transceiver and send the feedback signal to the positioning base station through the first data transceiver.

21. The system according to claim 14, wherein the data transceiver comprises a first data transceiver and a second data transceiver; the system further comprises: at least one connector; and the connector comprises an auxiliary positioner;
wherein one end of the first data transceiver is connected to the positioner, and the other end of the first data transceiver is connected to the auxiliary positioner; the second data transceiver is connected to the auxiliary positioner;
the connector is configured to perform information interaction with the terminal device through a positioning signal transceiving area of at least one of the first data transceiver and the second data transceiver, so as to generate an auxiliary sending feature and an auxiliary receiving feature of each piece of information, wherein the auxiliary sending feature comprises an auxiliary sending time or an auxiliary sending phase, and the auxiliary receiving feature comprises an auxiliary receiving time or an auxiliary receiving phase; and
the parser is configured to receive the auxiliary sending feature and the auxiliary receiving feature of each piece of information sent by at least one of the auxiliary positioner and the terminal device as well as a corresponding auxiliary positioner identifier and a corresponding terminal device identifier; determine at least one auxiliary transmission feature quantity according to each auxiliary sending feature and each auxiliary receiving feature as well as the corresponding auxiliary positioner identifier and the corresponding terminal device identifier, wherein the auxiliary transmission feature quantity comprises an auxiliary total transmission time or an auxiliary total transmission phase difference, and corresponds to the auxiliary positioner identifier and the terminal device identifier; and determine a second spatial coordinate of the terminal device according to each auxiliary transmission feature quantity and each auxiliary positioner identifier.

22. The system according to claim 20, wherein at least one of the positioning base station and the connector further comprises a communicator;
correspondingly, the data transceiver further comprises a communication signal transceiving area; and
the communicator is configured to input a communication signal into the data transceiver, so that the communication signal is sent from the communication signal transceiving area to an air.

23. The system according to claim 20, wherein the system further comprises: at least one load, wherein the load comprises a secondary auxiliary positioner;
one end of the data transceiver is connected to the positioner, and the other end of the data transceiver is connected to the secondary auxiliary positioner;
the load is configured to perform information interaction with the terminal device through the positioning signal transceiving area of the data transceiver, so as to generate a secondary auxiliary sending feature and a secondary auxiliary receiving feature of each piece of information, wherein the secondary auxiliary sending feature comprises a secondary auxiliary sending time or a secondary auxiliary sending phase, and the secondary auxiliary receiving feature comprises a secondary auxiliary receiving time or a secondary auxiliary receiving phase; and
the parser is configured to receive the secondary auxiliary sending feature and the secondary auxiliary receiving feature of each piece of information sent by at least one of the secondary auxiliary positioner and the terminal device as well as a corresponding secondary auxiliary positioner identifier and a corresponding terminal device identifier; determine at least one secondary auxiliary transmission feature quantity according to the secondary auxiliary sending feature and the secondary auxiliary receiving feature of each piece of information as well as the corresponding secondary auxiliary positioner identifier and the corresponding terminal device identifier, wherein the secondary auxiliary transmission feature quantity comprises a secondary auxiliary total transmission time or a secondary auxiliary total transmission phase difference, and corresponds to the secondary auxiliary positioner identifier and the terminal device identifier; and determine a third spatial coordinate of the terminal device according to each secondary auxiliary transmission feature quantity and each secondary auxiliary positioner identifier.

24. The system according to claim 23, wherein the load further comprises: an antenna;
the antenna is connected to the secondary auxiliary positioner; and
the load is further configured to perform information interaction with the terminal device through the antenna.

25. The system according to claim 14, wherein the parser is further configured to:
determine an identifier of a corresponding target positioning signal transceiving area according to each transmission feature quantity and each corresponding positioner identifier;
determine a priority of each transmission feature quantity according to the identifier of the target positioning signal transceiving area corresponding to each transmission feature quantity and the corresponding positioner identifier;
rank the transmission feature quantity in a descending order of priorities, so as to obtain a transmission feature quantity sequence; and
determine a spatial coordinate of the terminal device by using the first N transmission feature quantity in the transmission feature quantity sequence, wherein N is a positive integer.

26. A positioning method, applied to a positioning system, wherein the positioning system comprises a positioning base station, n data transceiver and a parser, wherein the positioning base station comprises a positioner, and each data transceiver comprises at least one positioning signal transceiving area, wherein n is a positive integer; the positioner is connected to one end of the data transceiver; and the method comprises:
performing, by the positioner, information interaction with a terminal device through the positioning signal transceiving area of the data transceiver, so as to generate a sending feature and a receiving feature of each piece of information, wherein the sending feature comprises a sending time or a sending phase, and the receiving feature comprises a receiving time or a receiving phase; and
receiving, by the parser, the sending feature and the receiving feature of each piece of information sent by at least one of the positioner and the terminal device as well as a corresponding positioner identifier and a corresponding terminal device identifier; determining at least one transmission feature quantity according to the sending feature and the receiving feature of each piece of information as well as the corresponding positioner identifier and the corresponding terminal device identifier, wherein the transmission feature quantity comprises a total transmission time or a total transmission phase difference, and corresponds to the positioner identifier and the terminal device identifier; and determining a first spatial coordinate of the terminal device according to each transmission feature quantity and each positioner identifier.

27. The method according to claim 26, wherein determining the first spatial coordinate of the terminal device according to each transmission feature quantity and each positioning module identifier comprises:
obtaining the number of the transmission feature quantity, and determining the first spatial coordinate of the terminal device according to the number of the transmission feature quantity, each positioner identifier and each transmission feature quantity.

28. The method according to claim 27, wherein obtaining the number of the transmission feature quantity, and determining the first spatial coordinate of the terminal device according to the number of the transmission feature quantity, each positioner identifier and each transmission feature quantity comprises:
in a condition that the number of the transmission feature quantity is greater than or equal to 3, determining a target position of each target positioner according to the positioner identifier, wherein the target positioner is a positioner that performs signal transmission and reception; determining an identifier of each corresponding target positioning signal transceiving area according to each transmission feature quantity and the corresponding positioner identifier, wherein the target positioning signal transceiving area comprises a positioning signal transceiving area through which each piece of information passes; searching for each piece of target structural information corresponding to the identifier of each target positioning signal transceiving area; and determining the first spatial coordinate of the terminal device according to each piece of target structural information, the target position of each target positioner and each transmission feature quantity.

29. The method according to claim 27, wherein obtaining the number of the transmission feature quantity, and determining the first spatial coordinate of the terminal device according to the number of the transmission feature quantity, each positioner identifier and each transmission feature quantity comprises:
in a condition that the number of the transmission feature quantity is 1 or 2, obtaining a preset reference coordinate; determining a target position of each target positioner according to the positioner identifier, wherein the target positioner is a positioner that performs signal transmission and reception; determining an identifier of each corresponding target positioning signal transceiving area according to each transmission feature quantity and the corresponding positioner identifier, wherein the target positioning signal transceiving area is a positioning signal transceiving area through which each piece of information passes; searching for each piece of target structural information corresponding to the identifier of each target positioning signal transceiving area; and determining the first spatial coordinate of the terminal device according to the preset reference coordinate, each piece of target structural information, the target position of each target positioner and each transmission feature quantity.

30. The method according to claim 26, wherein determining the first spatial coordinate of the terminal device according to each transmission feature quantity and each positioning module identifier comprises:
inputting a positioning signal to the data transceiver, and recording a sending time of the positioning signal; sending, by the data transceiver, the positioning signal from the positioning signal transceiving area to an air; receiving, by the data transceiver, a feedback signal, wherein the feedback signal is sent by the terminal device according to the positioning signal, and the feedback signal comprises the terminal device identifier; receiving, by the positioner, each feedback signal sent by the data transceiver and recording each receiving time corresponding to each feedback signal, and sending each sending time, each receiving time, the corresponding positioner identifier and the corresponding terminal device identifier to the parser; and determining, by the parser, each corresponding total transmission time according each sending time, each receiving time, the corresponding positioner identifier and the corresponding terminal device identifier; or
receiving, by the data transceiver, a positioning request transmitted by the terminal device through the positioning signal transceiving area, wherein the positioning request comprises a sending time of the positioning request and a corresponding terminal device identifier; receiving, by the positioner, each positioning request sent by the data transceiver and recording a receiving time of each positioning request, and sending the sending time of each positioning request, the receiving time of each positioning request, the corresponding positioner identifier and the corresponding terminal device identifier to the parser; and determining, by the parser, each corresponding total transmission time according to the sending time of each positioning request, the receiving time of each positioning request, the corresponding positioner identifier and the corresponding terminal device identifier; or receiving, by the data transceiver, a positioning request transmitted by the terminal device through the positioning signal transceiving area, wherein the positioning request comprises a sending time of the positioning request and a corresponding terminal device identifier;
receiving, by the positioner, each positioning request sent by the data transceiver and recording a receiving time of each positioning request, and inputting a positioning signal to the data transceiver and recording a sending time of each positioning signal; sending, by the data transceiver, the positioning signal from the positioning signal transceiving area to an air; receiving, by the data transceiver, a feedback signal and sending the feedback signal to the positioner, wherein the feedback signal is sent by the terminal device according to the positioning signal and comprises a sending time of the feedback signal and a corresponding terminal device identifier; receiving, by the positioning base station, each feedback signal sent by the data transceiver and recording a receiving time of each feedback signal, and sending the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioner identifier to the parser; and determining, by the parser, each total transmission time according to the receiving time of each feedback signal, the sending time of each feedback signal, the receiving time of each positioning request, the sending time of each positioning signal, the terminal device identifier corresponding to each positioning request, the terminal device identifier corresponding to each feedback signal, and the positioner identifier.

31. The method according to claim 26, wherein the data transceiver comprises a first data transceiver and a second data transceiver; and the system further comprises: at least one connector;
wherein one end of the first data transceiver is connected to the positioner, and the other end of the first data transceiver is connected to one end of the connector; the second data transceiver is connected to the connector; and
the method further comprises:
receiving a positioning signal input by the positioning base station through the first data transceiver and input the positioning signal into the second data transceiver, so that the positioning signal is sent to an air through the second data transceiver; and
receiving a feedback signal input by the terminal device through the second data transceiver and sending the feedback signal to the positioning base station through the first data transceiver.

32. The method according to claim 26, wherein the data transceiver comprises a first data transceiver and a second data transceiver; the system further comprises: at least one connector; and the connector comprises an auxiliary positioner;
wherein one end of the first data transceiver is connected to the positioner, and the other end of the first data transceiver is connected to the auxiliary positioner; the second data transceiver is connected to the auxiliary positioner;
the method further comprises:
performing information interaction with the terminal device through a positioning signal transceiving area of the first data transceiver and/or the second data transceiver, so as to generate an auxiliary sending feature and an auxiliary receiving feature of each piece of information, wherein the auxiliary sending feature comprises an auxiliary sending time or an auxiliary sending phase, and the auxiliary receiving feature comprises an auxiliary receiving time or an auxiliary receiving phase; and
receiving, by the parser, the auxiliary sending feature and the auxiliary receiving feature of each piece of information sent by the auxiliary positioner and/or the terminal device as well as a corresponding auxiliary positioner identifier and a corresponding terminal device identifier; determining at least one auxiliary transmission feature quantity according to each auxiliary sending feature and each auxiliary receiving feature as well as the corresponding auxiliary positioner identifier and the corresponding terminal device identifier, wherein the auxiliary transmission feature quantity comprises an auxiliary total transmission time or an auxiliary total transmission phase difference, and corresponds to the auxiliary positioner identifier and the terminal device identifier; and determining a second spatial coordinate of the terminal device according to each auxiliary transmission feature quantity and each auxiliary positioner identifier.

33. The method according to claim 26, wherein determining the first spatial coordinate of the terminal device according to each transmission feature quantity and each positioning module identifier comprises:
determining an identifier of a corresponding target positioning signal transceiving area according to each transmission feature quantity and each corresponding positioner identifier;
determining a priority of each transmission feature quantity according to the identifier of the target positioning signal transceiving area corresponding to each transmission feature quantity and the corresponding positioner identifier;
ranking the transmission feature quantity in a descending order of priorities, so as to obtain a transmission feature quantity sequence; and
determining a spatial coordinate of the terminal device by using the first N transmission feature quantity in the transmission feature quantity sequence, wherein N is a positive integer.
